(19) United States
(12) Patent Application Publication
(10) Pub. No.: US 2026/0312975 A1
(43) Pub. Date: Oct. 8, 2026

(54) BYZANTINE-FAULT-TOLERANT FEDERATED THREAT MODEL TRAINING FOR ADVERSARIALLY ROBUST AI SECURITY SYSTEMS

(71) Applicant: RAVI THEJA KAMBHAMPATI, Maple Valley, WA (US)

(72) Inventor: RAVI THEJA KAMBHAMPATI, Maple Valley, WA (US)

(21) Appl. No.: 19/686,931

(22) Filed: May 25, 2026

(51) Int. Cl. H04L 9/40; H04L 41/16

(52) U.S. Cl. CPC H04L 63/1425; H04L 41/16; H04L 63/083

(57) ABSTRACT

A Byzantine-fault-tolerant federated learning system and method for training artificial intelligence security threat detection models across distributed networks of AI security agents, wherein up to N/3 of participating agents may be adversarially compromised. A PRAF applies geometric median clipping, cosine similarity filtering, and credibility-weighted averaging to aggregate privatized gradient vectors while neutralising Byzantine gradient attacks. Per-agent credibility is dynamically modelled as Beta distribution updated through ground-truth prediction verification. A poisoning detection monitor applies sliding-window Kolmogorov-Smirnov test across federated rounds to detect coordinated multi-round poisoning attacks that evade per-round filtering. A rollback controller provides immediate reversion to cryptographically verified prior model version upon detection, supported by non-repudiation ledger implemented as a hash-chained directed acyclic graph providing complete forensic auditability of the training history.

### FIELD OF THE INVENTION

The present invention relates to federated machine learning systems for cybersecurity threat detection, and more particularly to methods and systems for training distributed AI security threat detection models in a Byzantine-fault-tolerant manner.

### BACKGROUND OF THE INVENTION

The proliferation of sophisticated, persistent, and coordinated cyber threats against enterprise networks, critical infrastructure operators, financial institutions, healthcare organizations, government entities, and cloud service providers has created an acute and rapidly growing demand for AI-driven threat detection systems capable of identifying and characterising attack campaigns at a speed and scale that far exceeds the capacity of unaided human security analysts. In response, security practitioners increasingly deploy networks of distributed AI security agent processes—autonomous software systems that continuously ingest and analyse security telemetry from diverse sources including network traffic metadata, endpoint detection and response logs, authentication event streams, cloud workload activity records, email security events, and industrial control system sensor outputs—to identify anomalous patterns indicative of unauthorised access, lateral movement, privilege escalation, data exfiltration, ransomware staging and deployment, denial-of-service attacks, supply-chain compromises, and other categories of cyber threat.

A foundational technical challenge in the operation of distributed AI security agent networks is the continuous training and updating of the underlying threat detection models. Because the threat landscape evolves at high velocity, with adversaries regularly developing novel attack techniques, exploit payloads, evasion strategies, and living-off-the-land procedures that are absent from historical training datasets, the threat detection models used by AI security agents must be retrained frequently on current security telemetry to maintain acceptable detection performance. Centralized training approaches, in which all security telemetry from all monitoring points is transmitted to a single training server for joint model training, introduce severe operational, security, and regulatory constraints. Such centralized approaches create a single high-value data repository that is itself an attractive target for adversarial compromise; they require substantial sustained network bandwidth for the continuous transmission of large-volume telemetry streams; and they are incompatible with data residency regulations, inter-organizational confidentiality obligations, and sovereignty requirements that prohibit the transfer of security event data across network perimeters, organizational boundaries, or national jurisdictions.

Federated learning, as introduced by McMahan, Moore, Ramage, Hampson, and Arcas in 2017, provides a mechanism by which a plurality of distributed clients may collaboratively train a shared machine learning model without transmitting raw training data to any central party. In the federated learning paradigm, each client trains a local model on its locally held private data, computes the gradient of the local model's loss function with respect to the current shared model parameters, and transmits only the computed gradient to a central aggregating party. The aggregating party combines the received gradients, typically by computing a weighted average, and applies the combined gradient as an update to the shared global model. The updated global model is then distributed to all clients for use as the starting point of the next round of local training. Because raw telemetry data is never transmitted beyond each agent's local environment, federated learning is well-suited to the distributed AI security agent deployment scenario and resolves the regulatory and confidentiality constraints of centralized training.

However, the federated learning paradigm introduces a critical vulnerability that is of special severity in the AI security context: Byzantine gradient poisoning attacks. In a Byzantine fault attack, one or more participating clients, in the context of the present invention, one or more AI Security Agent processes, have been compromised by adversaries who program the agent's gradient computation and transmission logic to produce and transmit adversarially crafted gradient vectors to the aggregating party, rather than the genuine gradients that would be computed from legitimate local training on genuine security telemetry. The term Byzantine, as used herein, refers to the Byzantine Generals Problem as formalised by Lamport, Shostak, and Pease in 1982, which characterises arbitrary, potentially coordinated malicious behaviour by a subset of participants in a distributed system. This vulnerability is of special severity in the AI security monitoring context for two compounding reasons. First, a threat actor who has successfully compromised a security monitoring agent has already achieved significant penetration of the target organization's network environment, meaning the attacker is already in a position to cause harm independently of any model poisoning activity. By additionally poisoning the global threat detection model, the attacker simultaneously reduces the organization's capacity to detect and respond to the ongoing compromise, creating a compounding effect of reduced defensive visibility at precisely the time it is most urgently needed. Second, in the AI security context, the global threat detection model is itself a critical operational asset, and its degradation may have direct, measurable, and potentially severe consequences for the organization's security posture, making the poisoning attack both easier to motivate and harder to tolerate than in typical commercial federated learning applications.

The specific categories of Byzantine gradient poisoning attack that the present invention is designed to neutralise include, without limitation, the following. Scale-amplification attacks, in which the adversarially controlled agent computes a genuine local gradient but multiplies it by a large positive scalar factor before transmission, causing the inflated gradient to dominate the simple arithmetic average used by naive federated aggregators and thereby steering the global model in the direction preferred by the attacker with disproportionate force. Sign-flipping attacks, in which the adversarially controlled agent negates its locally computed gradient before transmission, causing the transmitted gradient to push the global model's parameters in the direction exactly opposite to the true gradient of the legitimate training objective, thereby actively reversing the intended learning progress. Label-flipping attacks, in which the adversarially controlled agent trains its local model on a locally maintained and corrupted dataset in which the security threat classification labels of selected training samples have been deliberately reversed or replaced with incorrect labels, causing the local gradient to genuinely reflect a corrupted training objective without any post-hoc gradient modification being required. Gradient replacement attacks, in which the adversarially controlled agent discards its genuine local gradient entirely and transmits an adversarially optimised gradient vector that has been computed by solving an optimisation problem designed to move the global model toward a target compromised state while satisfying any statistical checks the aggregator is known to apply. Slow-poisoning attacks, also referred to in the literature as Byzantine-with-small-updates attacks, in which the adversarially controlled agent injects perturbations that are small in magnitude relative to the typical gradient norms observed among honest agents, thereby evading magnitude-based detection filters, but that are consistent in direction across many successive federated rounds, causing the global model parameters to drift gradually toward a compromised state over 100s or 1000s of rounds, with the resulting degradation of detection accuracy being so gradual that it may not be distinguished from ordinary model drift attributable to legitimate concept drift in the threat landscape until significant cumulative damage has accumulated.

Existing Byzantine-robust federated aggregation methods provide partial but fundamentally inadequate defences against the full range of Byzantine poisoning attacks described above. Krum, introduced by Blanchard, El Mhamdi, Guerraoui, and Stainer in 2017, selects as the global model update the single client gradient that has the smallest sum of distances to its n minus f minus two nearest neighbours, where n is the total number of clients and f is the assumed number of Byzantine clients. While Krum is provably resilient to Byzantine attacks under its stated assumptions, it suffers from the fundamental limitation that it uses only one client gradient per round, discarding all other information, leading to substantially reduced model accuracy relative to what could be achieved if all honest clients' gradients were incorporated. Bulyan, introduced by El Mhamdi, Guerraoui, and Rouault in 2018, addresses this limitation by first using Krum to select a subset of gradients and then applying a coordinate-wise trimmed mean to the selected subset, but inherits Krum's assumption of identically distributed client data. Coordinate-wise trimmed mean aggregators, which exclude the m largest and m smallest values in each coordinate dimension before averaging, are effective against scale-amplification attacks but provide no defence against sign-flipping attacks in which all corrupted gradients are within the trimming window. FLTrust, introduced by Cao, Fang, Yu, and Li in 2020, maintains a small server-side root dataset and weights client gradients by their cosine similarity with a server-computed gradient, but requires the central aggregator to maintain a labelled dataset of its own, which is unavailable in the AI security context where ground-truth threat labels are not available to the aggregator in real time. None of the foregoing methods provides any mechanism for detecting or recovering from poisoning that becomes apparent only after the compromised model has been deployed for inference, and none provides cryptographic non-repudiation for gradient submissions sufficient to support forensic attribution of detected poisoning to specific contributing agents. Furthermore, all existing methods assume that client data is identically or near-identically distributed, an assumption that is systematically violated in AI security agent networks where different agents observe categorically different types of security telemetry from different network environments, causing methods that rely on distributional homogeneity to systematically misidentify legitimate agents as Byzantine and incorrectly exclude their valid gradient information.

There accordingly exists a significant and longstanding need in the art for a Byzantine-fault-tolerant federated learning system and method that simultaneously addresses all of the foregoing limitations.

### BRIEF SUMMARY OF THE INVENTION

The present invention addresses the foregoing deficiencies in the prior art by providing a comprehensive, multi-layered, cryptographically grounded, and operationally deployable system and method for Byzantine-fault-tolerant federated training of AI security threat detection models across distributed networks of heterogeneous AI security agent processes.

In one aspect, the present invention provides a computer-implemented method for Byzantine-fault-tolerant federated training of an artificial intelligence security threat detection model across a plurality of distributed AI security agent processes, comprising: receiving privatized gradient vectors from AI security agent processes and verifying their digital signatures; computing the Geometric Median of the verified gradient vectors; applying a norm-based Geometric Median Clipping operation; applying a cosine similarity directional filtering operation; computing a Credibility-Weighted Average of surviving gradients; updating a Global Threat Detection Model; committing the updated model to a Non-Repudiation Ledger; computing a Kolmogorov-Smirnov statistic comparing current-round and reference gradient magnitude distributions; and, upon detection, reverting the model and initiating zero-knowledge proof provenance verification, all as described in detail herein.

In another aspect, the present invention provides a system for Byzantine-fault-tolerant federated security threat model training comprising a plurality of AI security agent processes, a PRAF Aggregator comprising a geometric median clipper, a cosine similarity filter, a Credibility-Weighted Averager, and a Poisoning Detection Monitor, a Global Threat Detection Model, a Rollback Controller, and a non-repudiation ledger, interconnected as described in detail herein.

In further aspect, the present invention provides one or more non-transitory computer-readable media storing instructions that, when executed by one or more processors, implement the method of the first broad aspect.

The foregoing summary is illustrative only and is not intended to be in any way limiting. In addition to the illustrative aspects, embodiments, and features described above, further aspects, embodiments, and features of the invention will become apparent by reference to the drawings and the following detailed description.

### BRIEF DESCRIPTION OF THE DRAWINGS

The accompanying drawings, which are incorporated in and form a part of this specification, illustrate preferred embodiments of the invention and, together with the description, serve to explain the principles of the invention. In the drawings:

FIG. 1 is a block diagram illustrating an overall system architecture of a Byzantine-fault-tolerant federated threat model training system in accordance with a first embodiment of the present invention.

FIG. 2 is a pipeline flow diagram illustrating a three-stage Poisoning-Resistant Aggregation Function (PRAF).

FIG. 3 is a cycle diagram illustrating a Per-Agent Credibility Model update cycle.

FIG. 4 is a combined chart and decision-flow diagram illustrating the Poisoning Detection Monitor.

FIG. 5 is a chain diagram illustrating a cryptographic version chain of the non-repudiation ledger.

### DETAILED DESCRIPTION OF THE INVENTION

In the following detailed description, reference is made to the accompanying drawings, which form a part hereof, and in which are shown by way of illustration specific embodiments in which the invention may be practised. These embodiments are described in sufficient detail to enable those skilled in the art to practise the invention, and it is to be understood that other embodiments may be utilised and that structural, logical, and procedural changes may be made without departing from the spirit and scope of the present invention as defined by the appended claims. The following detailed description is, therefore, not to be taken in a limiting sense. Where a range of values is provided, it is understood that each intervening value, to the tenth of a unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention.

As used herein, the term “artificial intelligence security agent process” refers to an autonomous software process executing on one or more computing nodes that is configured to continuously ingest security-relevant telemetry from a locally observed computing environment; to maintain a locally cached instantiation of the Global Threat Detection Model and perform real-time inference thereover; to train locally cached model instantiation on locally accumulated security telemetry using a local training objective; to compute a gradient of a local training objective with respect to current shared model parameters; to apply per-layer differential privacy noise to the gradient in accordance with the Gaussian Mechanism; to digitally sign the resulting privatised gradient vector using a private cryptographic key registered with the Poisoning-Resistant Aggregation Function Aggregator; and to transmit said signed privatised gradient vector to the Aggregator via a mutually authenticated encrypted connection. The term encompasses agent processes executing on on-premises enterprise servers, cloud virtual machine instances, containerised microservice environments, edge computing devices, network appliance firmware execution environments, and industrial control system monitoring endpoints, without limitation.

As used herein, the term “Byzantine agent” or “Byzantine agent process” refers to an artificial intelligence security agent process whose computing environment has been compromised by an adversary and whose gradient computation or transmission logic has been modified to produce and transmit adversarially crafted gradient vectors to the Poisoning-Resistant Aggregation Function Aggregator, rather than the genuine gradients derived from legitimate local training on genuine security telemetry. A Byzantine agent may exhibit any arbitrary transmission behaviour and is not required to be consistently adversarial; an agent is characterised as Byzantine if, in any given federated round, it transmits a gradient vector that does not faithfully represent the result of legitimate local training on unmanipulated locally observed security telemetry. The present invention is specifically designed to maintain correct operation when the total number f of simultaneously Byzantine agent processes satisfies f<N/3, where N is the total number of participating agent processes in a given federated round, without the system having prior knowledge of which specific agents are Byzantine.

As used herein, the term “Poisoning-Resistant Aggregation Function Aggregator” or “PRAF Aggregator” refers to a computing system comprising one or more processors and non-transitory computer-readable memory that is configured to receive a plurality of privatised gradient vectors from a plurality of artificial intelligence security agent processes; to verify the digital signature accompanying each received gradient vector; to apply the three-stage PRAF pipeline comprising the geometric median clipper, the cosine similarity filter, and the credibility-weighted averager; to update the global threat detection model with the resulting aggregated gradient; to commit each updated model version to the non-repudiation ledger; and to coordinate the poisoning detection monitor and the rollback controller. In the first embodiment, the PRAF Aggregator is deployed as a centralised cloud computing service with all cryptographic signing operations performed within a hardware security module. In the second embodiment, the PRAF Aggregator function is distributed among the artificial intelligence security agent processes using a rotating temporary aggregator designated by a deterministic verifiable random function. In the third embodiment, PRAF Aggregator functions are distributed across tenant aggregators and a global aggregator in a hierarchical architecture.

As used herein, the term “geometric median clipper” refers to the first stage of the PRAF pipeline that is configured to compute the geometric median g_{med} of a plurality of received gradient vectors using an iterative Weiszfeld algorithm; to compute, for each received gradient vector gᵢ, the norm ratio rᵢ defined as the ratio of the Euclidean norm of gᵢ to the Euclidean norm of g_{med}; and to rescale any gradient vector whose norm ratio rᵢ exceeds a configurable clipping multiplier τ so that the Euclidean norm of the rescaled vector equals τ times the Euclidean norm of g_{med}, with the direction of the vector preserved. The term “geometric median” as used herein refers to the vector in the parameter space that minimises the sum of Euclidean distances to all input gradient vectors, which is computed using the Weiszfeld algorithm initialised at the coordinate-wise median, employing a smoothing constant of 10⁻⁸ to prevent numerical instability, and terminating upon the step norm falling below a convergence tolerance of 10⁻⁶ or after 100 iterations, whichever condition occurs first. The geometric median clipper produces as output the first filtered set S1.

As used herein, the term “cosine similarity filter” refers to the second stage of the PRAF pipeline that is configured to compute, for each gradient vector gᵢ in the first filtered set S1, the cosine similarity between grand the Geometric Median g_{med}, defined as the inner product of gᵢ and g_{med} divided by the product of the Euclidean norms of gᵢ and g_{med}; and to exclude from further processing any gradient vector whose cosine similarity is strictly less than a configurable minimum cosine similarity threshold θ. The cosine similarity threshold θ has a preferred default value of 0.0, such that the cosine similarity filter excludes only gradient vectors whose directional deviation from the geometric median exceeds 90%, thereby neutralising sign-flipping and directional Byzantine attacks. The cosine similarity filter produces as output the second filtered set S2, and logs each inclusion or exclusion decision, together with the computed cosine similarity value, to the non-repudiation ledger as part of the per-round aggregation decision record.

As used herein, the term “credibility-weighted averager” refers to the third stage of the PRAF pipeline that is configured to compute the aggregated gradient g_{agg} as the weighted average of all gradient vectors in the second filtered set S2, wherein each gradient vector is weighted by the Credibility Weight wᵢ of the agent process that submitted it, and the weighted sum is divided by the sum of all Credibility Weights of agent processes whose gradient vectors are included in S2. As used herein, the term “Credibility Weight” of an agent process refers to the ratio of that agent process's cumulative correct-prediction count at to the arithmetic sum of its cumulative correct-prediction count αᵢ and its cumulative incorrect-prediction count βᵢ, subject to a configurable floor value wₘᵢₙ, wherein αᵢ is incremented by one each time the agent process's gradient submission for a federated round is associated with a non-negative change in the threat detection F1-score of the updated Global Threat Detection Model on the agent process's local evaluation dataset, and βᵢ is incremented by one each time the agent process's gradient submission is associated with a negative change in said F1-score. Both αᵢ and βᵢ are initialised to one at agent registration, yielding an initial Credibility Weight of one-half corresponding to the mean of the uniform prior Beta distribution Beta(1,1).

As used herein, the term “poisoning detection monitor” refers to the process executing within the PRAF aggregator that is configured to compute, after each federated round r, the Kolmogorov-Smirnov statistic KSᵣ defined as the supremum over all non-negative real values of the absolute difference between the empirical cumulative distribution function of the Euclidean norms of all gradient vectors received in round r and a reference empirical cumulative distribution function computed as the point-wise average of the empirical cumulative distribution functions of gradient vector Euclidean norms from each of the K most recently preceding federated rounds; and to raise a poisoning detection alert when KSᵣ exceeds a configurable detection threshold h. The poisoning detection monitor is specifically designed to detect coordinated multi-round poisoning attacks whose per-round gradient magnitude perturbations are individually too small to be excluded by the geometric median clipper or the cosine similarity filter but whose aggregate statistical effect on the gradient magnitude distribution over multiple rounds is detectable by the Kolmogorov-Smirnov test.

As used herein, the term “global threat detection model” refers to the shared artificial intelligence model collaboratively trained across all registered artificial intelligence security agent processes through the federated learning process described herein, which is configured to classify observed security telemetry events as benign or as belonging to one or more threat categories in a defined threat taxonomy. The global threat detection model is updated each federated round by applying the aggregated gradient g_{agg} produced by the credibility-weighted averager to the current model parameters Or using the Adam optimiser, producing updated model parameters θᵣ₊₁. Each version of the global threat detection model produced by a federated round update is committed to the non-repudiation ledger as a version node. Upon activation of the rollback controller, the active global threat detection model is reverted to the model parameters corresponding to the most recently committed verified-clean version node in the non-repudiation ledger.

As used herein, the term “rollback controller” refers to the process that, upon receiving a poisoning detection alert from the poisoning detection monitor, is configured to suspend acceptance of further gradient submissions for the current federated round; to query the non-repudiation ledger to identify the most recently committed version node bearing a verified-clean marker; to revert the active global threat detection model to the model parameters corresponding to the identified verified-clean version within a target latency of two seconds from receipt of the poisoning detection alert; to broadcast a signed reversion notification to all registered artificial intelligence security agent processes comprising the version identifier, the SHA-3-256 cryptographic hash of the restored model parameters, and the digital signature of the Rollback Controller over the notification; to commit a rollback event record to the non-repudiation ledger; and to concurrently initiate a zero-knowledge proof verification round in which each registered artificial intelligence security agent process is required to submit a cryptographic proof of training data provenance within a configurable timeout.

As used herein, the term “non-repudiation ledger” refers to a data structure implemented as a directed acyclic graph of model version nodes, wherein each model version node stores: (i) a SHA-3-256 cryptographic hash of the model weight tensor of the corresponding global threat detection model version; (ii) a complete aggregation decision record for the federated round that produced that model version, comprising for each participating agent process the norm ratio rᵢ computed in the geometric median clipper, the geometric median clipper inclusion decision, the cosine similarity value computed in the cosine similarity filter, the cosine similarity filter inclusion or exclusion decision, and the credibility weight wᵢ applied in the credibility-weighted averager; (iii) the adversarial benchmark evaluation metrics of the model version comprising the threat detection F1-score, precision, recall, and area under the receiver operating characteristic curve on a held-out adversarial benchmark dataset; (iv) a verified-clean marker set to true if and only if all adversarial benchmark evaluation metrics meet their respective configurable minimum thresholds; (v) a Unix timestamp; (vi) a cryptographic hash pointer containing the SHA-3-256 hash of the complete content of the immediately preceding model version node; and (vii) the digital signature of the PRAF aggregator over the complete content of the node, computed using the aggregator's private key held in the hardware security module. The cryptographic hash chain structure of the non-repudiation ledger renders retroactive modification of any historical version node immediately detectable as a chain integrity violation.

As used herein, the term “verified-clean,” when used as a marker or designation for a version node in the non-repudiation ledger, means that the global threat detection model version represented by that node achieved, on the held-out adversarial benchmark dataset evaluated at the time of node commitment, all adversarial benchmark evaluation metrics at or above their respective configurable minimum thresholds. Only version nodes bearing a verified-clean marker are eligible to serve as rollback targets upon activation of the rollback controller. The term “most recently committed verified-clean version,” as used in the claims and in this description, refers to the verified-clean version node in the Non-Repudiation Ledger having the most recent Unix timestamp among all version nodes bearing a Verified-Clean marker.

As used herein, the term “privatised gradient vector” refers to a gradient vector of a local training objective with respect to the current shared model parameters, to which per-layer Gaussian differential privacy noise has been added prior to transmission to the Poisoning-Resistant Aggregation Function Aggregator, wherein for each model layer [symbol] , the standard deviation of the added Gaussian noise is computed as the product of the global gradient clipping threshold C and the gradient sensitivity [symbol] of that layer, divided by the per-round privacy budget ε_{round}, and wherein the gradient sensitivity [symbol] is defined as the maximum, over all training examples x in a calibration dataset, of the Euclidean norm of the difference between the layer [symbol] gradient computed on the full calibration dataset and the layer [symbol] gradient computed with example x removed. The privatised gradient vector is digitally signed by the transmitting agent process using its registered private key before transmission.

As used herein, the term “Hardware Security Module” refers to a tamper-resistant hardware device certified to Federal Information Processing Standard 140-3 Level 3 or an equivalent standard that maintains the private cryptographic signing key of the Poisoning-Resistant Aggregation Function Aggregator in a hardware boundary inaccessible to the host operating system or any software process executing on the Aggregator's host platform, and within which all cryptographic signing operations of the Aggregator, including the generation of digital signatures over Non-Repudiation Ledger version nodes, are performed.

As used herein, the term “zero-knowledge proof,” in the context of the zero-knowledge proof verification round, refers to a cryptographic proof constructed using a succinct non-interactive argument of knowledge proof system, preferably implementing the Groth16 proof scheme applied to an arithmetic circuit encoding the data quality predicates of the data quality predicate set P_{quality}, that allows a proving agent process to demonstrate that its gradient vector submissions during a specified inspection window of preceding federated rounds were computed from a local training dataset satisfying a minimum dataset size criterion nₘᵢₙ, a maximum class imbalance ratio criterion Pmax, and a minimum feature distribution entropy criterion Hₘᵢₙ, without revealing any information about the content of the local training dataset to the Poisoning-Resistant Aggregation Function Aggregator or to any other party.

As used herein, the term “federated round” refers to a single iteration of the federated training process in which the Poisoning-Resistant Aggregation Function Aggregator broadcasts a round-start notification to all registered artificial intelligence security agent processes; each agent process performs local model training, applies differential privacy noise, digitally signs and transmits a privatised gradient vector; the aggregator applies the three-stage poisoning-resistant aggregation function pipeline to the received gradient vectors; the aggregator updates the global threat detection model; the aggregator commits the updated model as a version node to the non-repudiation ledger; the aggregator updates the credibility weight of each participating agent process; and the poisoning detection monitor computes the Kolmogorov-Smirnov statistic for the round and evaluates it against the detection threshold. Each such iteration constitutes one federated round, indexed by the round index r.

As used herein, the singular forms ‘a,’ ‘an,’ and ‘the’ include plural referents unless the context clearly dictates otherwise. The terms ‘comprises,’ ‘comprising,’ ‘includes,’ ‘including,’ or ‘having’ are intended to specify the presence of stated features, integers, steps, operations, elements, or components, but do not preclude the presence or addition of one or more other features, integers, steps, operations, elements, components, or groups thereof. As used herein, the term ‘and/or’ includes any and all combinations of one or more of the associated listed items. As used herein, the phrases ‘at least one of’ and ‘one or more of,’ when used with a list of items, means that different combinations of one or more of the listed items may be used and only one item in the list may be needed. As used herein, ‘approximately,’ ‘about,’ and ‘substantially’ are intended to include the degree of error associated with measurement of a particular quantity based upon the equipment available at the time of filing the application.

It will be understood that information, signals, data, and algorithms may be represented using any of a variety of technologies and techniques. For example, data, instructions, commands, information, signals, bits, symbols, and chips that may be referenced throughout this description may be represented by voltages, currents, electromagnetic waves, magnetic fields or particles, optical fields or particles, or any combination thereof. It will be further understood that the various illustrative logical blocks, modules, circuits, and algorithm steps described in connection with the embodiments may be implemented as electronic hardware, computer software stored on non-transitory computer-readable media, or combinations of both. To clearly illustrate the interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, and such implementation decisions should not be interpreted as causing a departure from the scope of the present invention.

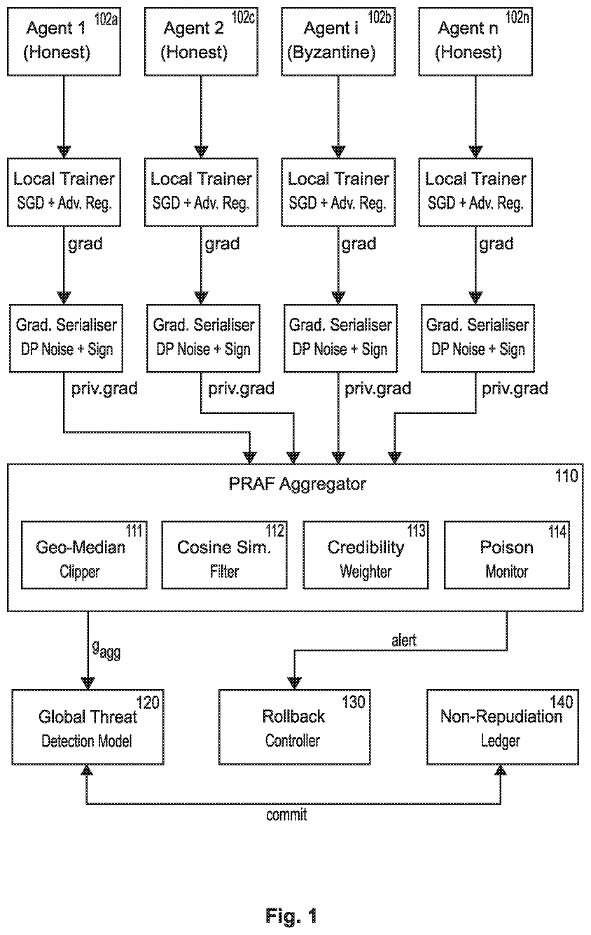

Referring now to FIG. 1, a system 100 for Byzantine-fault-tolerant federated training of an AI security threat detection model in accordance with a first embodiment will be described in full detail. The system 100 comprises a distributed layer of AI Security Agent processes 102a through 102n, a Poisoning-Resistant Aggregation Function (PRAF) Aggregator 110, a global threat detection model 120, a rollback controller 130, and a non-repudiation ledger 140. The PRAF Aggregator 110 comprises internally a geometric median clipper 111, a cosine similarity filter 112, a credibility-weighted averager 113, and a poisoning detection monitor 114. In the first embodiment, the PRAF Aggregator 110 is deployed as a centralized service executing on one or more cloud computing nodes provisioned for dedicated use by the operating organization, the PRAF aggregator's cryptographic signing operations being performed within a hardware security module that holds the aggregator's private signing key in a tamper-resistant hardware boundary inaccessible to the host operating system. AI security agent processes 102a through 102n execute on heterogeneous distributed computing infrastructure including but not limited to on-premises enterprise servers, cloud virtual machine instances, containerized microservice environments, edge computing devices, network appliance firmware execution environments, and industrial control system monitoring endpoints. The number N of simultaneously participating AI Security Agent processes may range from two to tens of thousands, and the system 100 is specifically designed to maintain correct operation when f of the N agents are simultaneously Byzantine. The Byzantine tolerance condition, established by the foundational results of Lamport, Shostak, and Pease (1982), is as follows:

$$f < \frac{N}{3}$$

where, f is number of Byzantine agents; and N is total participating agents.

Each AI Security Agent process 102 registered with the system 100 is an autonomous software process configured to perform the following principal functions. First, the agent process continuously observes and ingests security-relevant telemetry from its assigned local computing environment, including without limitation network traffic metadata, system call audit logs, authentication and authorization event records, file system activity records, process execution records, cloud workload activity logs, email security event records, and any other data streams that may indicate the presence, staging, or execution of cyber threats. Then, the agent process maintains a locally cached instantiation of the global threat detection model 120 and uses that instantiation to perform real-time inference over observed telemetry events, classifying each event or event sequence as benign or as belonging to one or more threat categories in a defined threat taxonomy. Further, the agent process trains the local model instantiation on locally accumulated security telemetry using a local training objective that in the preferred embodiment comprises a cross-entropy classification loss over the threat taxonomy and an adversarial robustness regularization term computed as the worst-case classification loss under Projected Gradient Descent perturbations of bounded L-infinity magnitude applied to the input telemetry feature vectors. Then, the agent process computes the gradient of the combined local training objective with respect to the current shared model parameters, applies per-layer differential privacy noise calibrated to the layer's gradient sensitivity and the per-round privacy budget, digitally signs the resulting privatized gradient vector using the agent's private key stored in the agent's local secure enclave, and transmits the signed privatized gradient vector to the PRAF Aggregator 110 via a mutually authenticated transport layer security (TLS) connection established using X.509 certificates issued by the system's certificate authority. The digital signature serves the dual purpose of authenticating the gradient submission to its source and providing cryptographic non-repudiation: because the agent's private key is exclusively associated with that specific registered agent, a signed gradient submission constitutes a verifiable and irrefutable record that that agent submitted that specific gradient value in that specific federated round.

Among the AI security agent processes 102a through 102n, element 102b in FIG. 1 represents a Byzantine Agent—an agent whose computing environment has been compromised by an adversary who has modified the agent's gradient computation or transmission logic to produce and transmit adversarially crafted gradient vectors. The system 100 is designed to operate correctly when any number f of agents satisfying f less than N divided by three are simultaneously Byzantine, without the system knowing a priori which agents are Byzantine. The three-stage PRAF pipeline described hereinafter provides layered defence against all known categories of Byzantine attack simultaneously, such that an adversary would need to deploy attack techniques spanning multiple categories simultaneously while also circumventing the cross-round Kolmogorov-Smirnov detection mechanism to achieve a significant cumulative poisoning effect.

The per-round local training procedure performed by each honest AI Security Agent process will now be described in detail. At the commencement of each federated round r, the PRAF Aggregator 110 broadcasts a round-start notification to all registered agents comprising the round index r, a cryptographic commitment to the SHA-3-256 hash of the current model parameter tensor θᵣ, and a cryptographic timestamp. Each agent verifies that its locally cached model parameter hash matches the committed hash before proceeding, thereby detecting any in-transit corruption of the distributed model parameters. The agent then trains its local model on its accumulated local dataset Di for E local epochs using mini-batch stochastic gradient descent with a configurable batch size having a preferred default of thirty-two samples and a local learning rate schedule implementing cosine annealing decay, beginning at an initial local learning rate of 0.01 and decaying to 0.001 over the E epochs. The number of local epochs E has a preferred default value of 5, calibrated to provide a sufficient local update while limiting the drift of local model parameters away from the global model that could cause honest agents' gradients to appear anomalous to the PRAF filtering stages. Upon completion of local training, the agent computes the full gradient Gᵢ of the combined local training objective with respect to the model parameters at the beginning of round r. For each model layer [symbol] , the differential privacy noise standard deviation [symbol] is computed as:

$${σ}_{ℓ} = \frac{C \cdot {Δ}_{ℓ}}{{ε}_{round}}$$

where, [symbol] is per-layer noise standard deviation for model layer [symbol] ; C is the global gradient clipping threshold; [symbol] is the gradient sensitivity of layer [symbol] ; and ε_{round} is the per-round differential privacy budget.

The gradient sensitivity Δ [symbol] is formally defined as:

$${Δ}_{l} = {max}_{x ∈ D} {‖ {∇}_{ℓ} ( D ) - {∇}_{ℓ} ( D ∖ x ) ‖}_{2}$$

where, [symbol] is the gradient sensitivity of layer [symbol] ; [symbol] (D) is the gradient of layer [symbol] computed on the full dataset D; [symbol] (D\x) is the gradient of layer [symbol] computed on the dataset with example x removed; and the supremum is taken over all training examples x in the calibration dataset D.

Independent Gaussian noise with mean zero and standard deviation [symbol] is sampled and added to the gradient of each layer [symbol] , producing the privatized gradient vector gᵢ. The cumulative differential privacy expenditure across all federated rounds is tracked using the moments accountant method introduced by Abadi, Chu, Goodfellow, McMahan, Mironov, Talwar, and Zhang in 2016, and the per-round budget ε_{round} is automatically reduced in subsequent rounds when the projected cumulative expenditure over the remaining operational lifetime of the system would otherwise exceed a configurable total lifetime privacy budget εₜₒₜₐₗ, ensuring that the differential privacy guarantee is maintained throughout the system's complete operational lifetime.

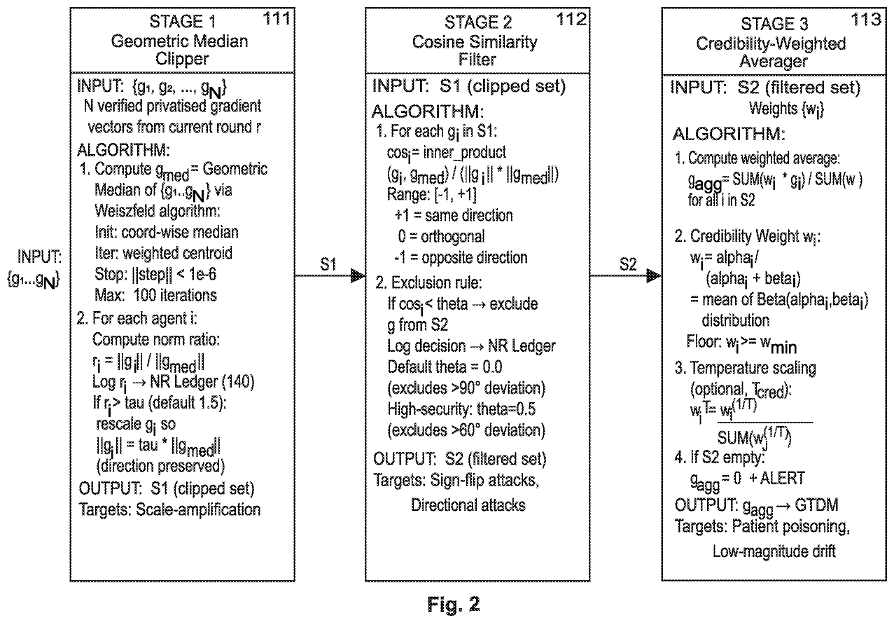

Referring now to FIG. 2, the multi-staged Poisoning-Resistant Aggregation Function, hereinafter the PRAF, will be described in complete detail. The PRAF receives as input the set of N privatized gradient vectors received and signature-verified in the current federated round r, and produces as output a single aggregated gradient gage that is applied to update the global threat detection model 120. Each of the stages is designed to neutralize a distinct category of Byzantine attack, and together they provide layered defense resilient to adversaries who simultaneously employ multiple attack strategies across different Byzantine agents.

At stage 1, the geometric median clipper 111, operates as follows. The Geometric Median of the N received gradient vectors, denoted as g_{med}, is the vector in the parameter space that minimises the sum of Euclidean distances to all N received gradient vectors. It is computed iteratively using the Weiszfeld algorithm, which is initialized at the coordinate-wise median of the N input vectors—a choice that provides a robust starting point not disproportionately influenced by any outlying gradient value—and iterates by computing at each iteration t the update as follows, where the smoothing constant εₛ equals 10⁻⁸ and is added to each denominator to prevent numerical instability when any input gradient vector coincides exactly with the current estimate:

$${g}_{med ( t + 1 )} = \frac{{\sum }_{{i}_{= 1}}^{N} \frac{{g}_{i}}{‖ {g}_{i} - {g}_{med ( t )} ‖ + {ε}_{s}}}{{\sum }_{{i}_{= 1}}^{N} \frac{{g}_{i}}{‖ {g}_{i} - {g}_{med ( t )} ‖ + {ε}_{s}}}$$

The algorithm terminates when the Euclidean norm of the update step falls below a convergence tolerance of 10⁻⁶, or after a maximum of 100 iterations, whichever condition is first satisfied. The Geometric Median possesses the property that the contribution of any single input gradient vector to its value is bounded regardless of that vector's magnitude, a property that distinguishes it fundamentally from the arithmetic mean, which can be shifted arbitrarily by a single gradient with an arbitrarily large magnitude. This bounded-influence property renders the Geometric Median inherently robust to scale-amplification Byzantine attacks. Following computation of g_{med}, the Clipper inspects the Euclidean norm of each received gradient gᵢ and computes the norm ratio rᵢ:

$${r}_{i} = \frac{‖ {g}_{i} ‖ {1}_{2}}{{‖ {g}_{med} ‖}_{2}} ; clip if {r}_{i} > τ$$

where, rᵢ is the norm ratio for agent i; ∥gᵢ∥₂ is the Euclidean norm of the gradient of agent i; ∥g_{med}∥₂ is the Euclidean norm of the Geometric Median; and τ is the configurable clipping multiplier with a preferred default value of 1.5. Any gradient gᵢ for which rᵢ exceeds τ is rescaled so that its Euclidean norm equals exactly t times the Euclidean norm of g_{med}, with direction preserved, according to the following rescaling rule:

$${\tilde{g}}_{i} = {g}_{i} \cdot \frac{τ \cdot {‖ {g}_{med} ‖}_{2}}{{‖ {g}_{i} ‖}_{2}} if {‖ {g}_{i} ‖}_{2} > τ {‖ {g}_{med} ‖}_{2}$$

The norm ratio rᵢ for each agent is logged to the non-repudiation ledger 140. The output of Stage 1 is the set S1 of norm-clipped gradient vectors, which has the same cardinality as the input set since clipping rescales rather than excludes.

Stage 2, the cosine similarity filter 112, operates as follows. For each gradient vector gᵢ in S1, the cosine similarity between gᵢ and the Geometric Median g_{med} is computed and compared to the minimum threshold θ:

$${cos}_{i} = \frac{〈 {g}_{i} , {g}_{med} 〉}{‖ {g}_{i} ‖ \cdot ‖ {g}_{med} ‖} ; exclude if {cos}_{i} < θ$$

where, cosᵢ is the cosine similarity between gradient gᵢ and the Geometric Median g_{med}; [symbol] gᵢ, g_{med} [symbol] is the Euclidean inner product of the two vectors; and ∥gᵢ∥·∥g_{med}∥ is the product of their Euclidean norms. This cosine similarity value measures the directional agreement between gᵢ and the consensus gradient direction represented by g_{med}, taking the value positive one when the vectors are perfectly aligned, zero when they are orthogonal, and negative one when they are antiparallel. Any gradient gᵢ whose cosine similarity with g_{med} is strictly less than the configurable minimum threshold θ is excluded from S2, which is the output set of Stage 2. The threshold θ has a preferred default value of 0.0, meaning that Stage 2 excludes only gradient vectors that lie strictly in the open directional hemisphere opposite to g_{med}. In deployments with a lower proportion of legitimate agent diversity and a higher suspected proportion of Byzantine agents, the threshold may be raised to 0.3, 0.5, or 0.7, corresponding to maximum permissible angular deviations of approximately 73, 60, and 45 degrees respectively. The exclusion or inclusion decision for each agent, together with the computed cosine similarity value, is logged to the non-repudiation ledger 140 as part of the per-round PRAF decision record. Stage 2 is specifically designed to neutralize sign-flipping and directional Byzantine attacks in which the adversarial gradient vector points in a direction substantially opposite or orthogonal to the consensus gradient direction.

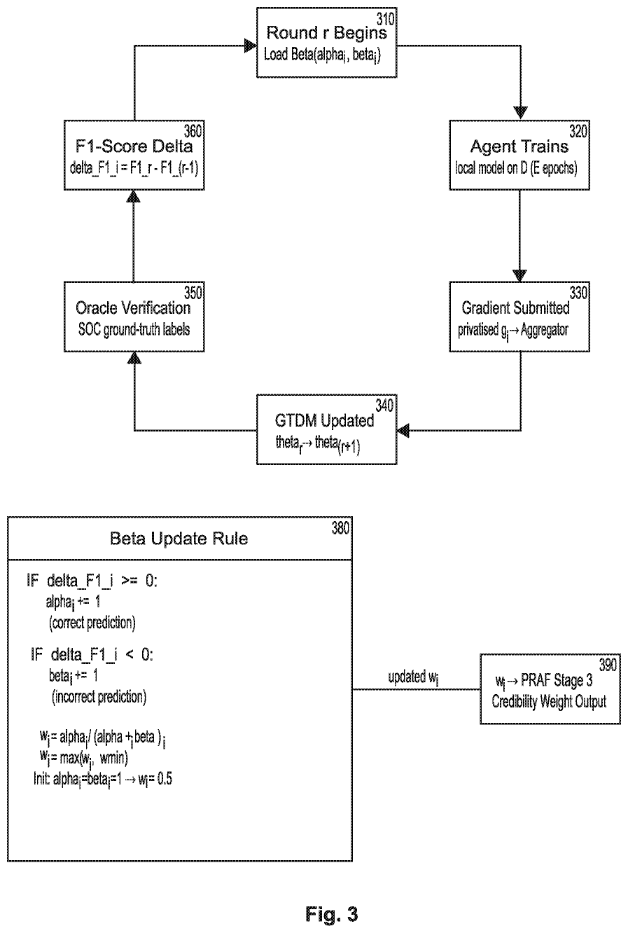

Stage 3, the credibility-weighted averager 113, operates as follows. The aggregated gradient g_{agg} is computed as the weighted average of all gradient vectors in S2:

$${g}_{agg} = \frac{{\sum }_{i ∈ {S}_{2}} {w}_{i} \cdot {g}_{i}}{{\sum }_{i ∈ {S}_{2}} {w}_{i}}$$

where, g_{agg} is the aggregated gradient; S2 is the set of gradient vectors surviving Stages 1 and 2; wᵢ is the credibility weight of the agent that submitted gradient gᵢ; and gᵢ is the privatized gradient vector of agent i. This normalization by the sum of weights ensures that the magnitude of g_{agg} is independent of the total number of gradients in S2, maintaining a consistent effective learning rate regardless of how many gradients are excluded in a given round. In the edge case where S2 is empty—meaning all received gradient vectors have been excluded by Stages 1 and 2 combined—Stage 3 returns a zero gradient vector, the global threat detection model 120 is not updated for that round, and a critical alert is issued to the system administrator. The credibility weights wᵢ are derived from per-agent Beta distribution parameters as described below with reference to FIG. 3. In a preferred variant, a temperature scaling parameter T_{cred} is applied by raising each wᵢ to the power of the reciprocal of T_{cred} and normalizing the results to sum to one:

$${w}_{i}^{T} = \frac{{w}_{i}^{\frac{1}{{T}_{cred}}}}{{\sum }_{{j}_{∈ {S}_{2}}} {w}_{j}^{\frac{1}{{T}_{cred}}}}$$

where,

$${w}_{i}^{T}$$

is the temperature-scaled credibility weight of agent i; T_{cred} is the temperature parameter; and the sum in the denominator ranges over all agents j whose gradients are in S₂. A T_{cred} value less than one sharpens the weight distribution toward the highest-credibility agents and T_{cred} greater than one flattens it toward a uniform average. The Credibility Weight applied to each agent's gradient in Stage 3, together with the resulting g_{agg}, are logged to the non-repudiation ledger 140.

Referring now to FIG. 3, the per-agent credibility model and its Beta distribution update cycle will be described in complete detail. For each registered AI security agent process i, the PRAF Aggregator 110 maintains a pair of non-negative integer count parameters αᵢ and βᵢ that together define a Beta probability distribution, denoted Beta (αᵢ, βᵢ), over the unit interval zero to one. The Credibility Weight wᵢ of agent i is defined as:

$${w}_{i} = \frac{{α}_{i}}{{α}_{i} + {β}_{i}} = E [ Beta ( {α}_{i} , {β}_{i} ) ] ; {w}_{i} \geq {w}_{min}$$

where, wᵢ is the Credibility Weight of agent i; αᵢ is the cumulative correct-prediction count of agent i; βᵢ is the cumulative incorrect-prediction count of agent i; and wₘᵢₙ is the configurable floor value with a preferred default of 0.05. Intuitively, at counts the number of historical federated rounds in which agent i's gradient submission is associated with an improvement or stable maintenance of the global threat detection model's performance on agent i's local evaluation data, while βᵢ counts the number of rounds in which agent i's submission is associated with a deterioration.

At the time of initial registration of a new AI Security Agent process, both αᵢ and βᵢ are initialised to one, yielding an initial Credibility Weight of wᵢ equal to 0.5. This initialisation corresponds to the mean of the non-informative uniform prior distribution Beta(1, 1), reflecting maximum uncertainty about the new agent's true credibility. As described at the Round start node 310 in FIG. 3, at the beginning of each federated round r the current values of αᵢ and βᵢ for all agents are loaded from the PRAF aggregator's persistent registry. Following local training at node 320 and gradient submission at node 330, the PRAF aggregator 110 completes the PRAF computation and updates the global threat detection model 120 at node 340. The aggregator then evaluates the updated model on each agent i's designated local evaluation dataset at the oracle verification node 350. The F1-score change ΔF1ᵢ; is computed at the F1-Score Delta node 360 as:

$$Δ F {1}_{i} = F {1}_{r , i} - F {1}_{r - 1 , i}$$

where, ΔF1ᵢ is the change in F1-score for agent i; F1_{r,i} is the F1-score of the updated model at round r on agent i's local evaluation dataset; and F1_{r-1,i} is the F1-score at the preceding round on the same evaluation dataset. The Beta update rule 380 of FIG. 3 specifies the following update logic:

$${α}_{i} += 1 if Δ F {1}_{i} \geq 0 ;$$

$${β}_{i} += 1 if Δ F {1}_{i} < 0$$

where, αᵢ is incremented by one when the F1-score change is non-negative, indicating that agent i's gradient submission contributed to an improvement or maintenance of model performance; and βᵢ is incremented by one when the F1-score change is negative, indicating that agent i's submission is associated with a performance deterioration. After updating αᵢ or βᵢ, the new Credibility Weight is recomputed per the formula mentioned above. A configurable floor wₘᵢₙ, having a preferred default value of 0.05, is enforced: if the recomputed wᵢ is less than wₘᵢₙ, it is set equal to wₘᵢₙ. The floor ensures that legitimate agents experiencing transient data distribution shifts, hardware faults, or network anomalies are not permanently excluded but retain a residual non-zero contribution weight that allows them to recover their credibility over subsequent rounds. The updated values of αᵢ, βᵢ, and wᵢ for all agents are committed to the non-repudiation ledger 140 after each round update, providing a complete and tamper-evident historical record of the evolution of each agent's credibility. The updated wᵢ flows through the credibility weight output node 390 to Stage 3 of the PRAF aggregator 113 for application in the next round.

In one embodiment, a time-decay adjustment is applied to the effective credibility weight of agents that have been absent from federated rounds for an extended period, in order to prevent stale high credibility weights from conferring undue influence on an agent that rejoins after a long absence. Specifically, for an agent that has not participated in t_{inactive} consecutive rounds, the effective Credibility Weight applied in Stage 3 is computed as:

$${w}_{i}^{eff} = max ( {w}_{min} , ( {w}_{i} - {w}_{min} ) \cdot {e}^{- {λ}_{d} \cdot {t}_{i n a c t i v e}} )$$

where,

$${w}_{i}^{eff}$$

is the effective Credibility Weight applied in Stage 3 for the absent agent; wₘᵢₙ is the configurable Credibility Weight floor; wᵢ is the agent's stored Credibility Weight; λ_{d} is a configurable decay rate with preferred default of 0.05 per inactive round; and t_{inactive} is the number of consecutive rounds in which the agent has not transmitted a gradient. This decay causes a long-absent agent's effective weight to converge toward wₘᵢₙ, ensuring conservative treatment of returning agents until their accuracy track record is re-established through active participation. The stored parameters αᵢ and βᵢ are not modified by this decay and continue to reflect the agent's historical track record faithfully.

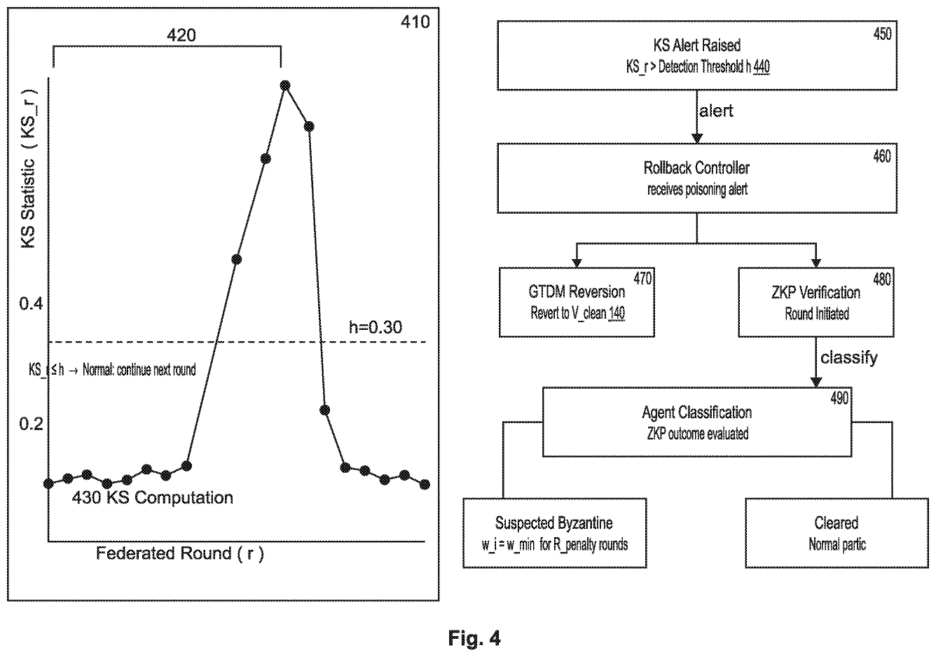

Referring now to FIG. 4, the poisoning detection monitor 114 and the rollback controller 130 will be described in complete detail. The poisoning detection monitor 114 operates as a continuous background process executing within the PRAF Aggregator 110 and is specifically designed to detect coordinated slow-poisoning attacks that inject individually sub-threshold perturbations across many successive federated rounds, which would pass all PRAF stages individually in each round but produce a detectable statistical signature when the distribution of gradient magnitudes across rounds is examined longitudinally.

After each federated round r, the Poisoning Detection Monitor 114 computes the empirical cumulative distribution function Fᵣ of the set of Euclidean norms of all N gradient vectors received in round r, including those that were excluded by Stage 1 or Stage 2 of the PRAF, since the complete set of received gradients provides a richer statistical signal for cross-round comparison than the filtered subset. The reference distribution window 420 shown in FIG. 4 maintains the K most recently preceding rounds' empirical distributions {F{r−K}, F{r−K+1}, . . . , F{r−1}}, where K is a configurable parameter with a preferred default of 10. The reference distribution F_{ref} is computed as the point-wise average of these K distributions:

$${F}_{ref} ( x ) = \frac{1}{K} {\sum }_{{j}_{= 1}}^{K} {F}_{r - j} ( x )$$

The KS Computation module 430 then computes the Kolmogorov-Smirnov statistic KSᵣ for round r:

$${KS}_{r} = {sup}_{x \geq 0} \vert {F}_{r} ( x ) - {F}_{ref} ( x ) \vert$$

where, KSᵣ is the Kolmogorov-Smirnov statistic for round r; Fᵣ(x) is the empirical cumulative distribution function of gradient Euclidean norms observed in round r; F_{ref}(x) is the reference distribution; and the supremum is taken over all non-negative real values x. KSᵣ takes values in the interval zero to one, with zero indicating perfect agreement between the current-round and reference distributions and one indicating maximum distributional divergence. During normal operation, KSᵣ remains near zero. When a coordinated poisoning attack causes a significant fraction of agents to simultaneously shift their gradient magnitude distributions away from the historical reference, KSᵣ rises sharply, as illustrated in the left panel of FIG. 4.

The threshold comparator evaluates whether KSᵣ exceeds the Detection Threshold h. The preferred default value of h is 0.30. This threshold may be calibrated empirically for a specific deployment by operating the system with a known-honest agent population for a calibration period of at least one hundred rounds, recording the maximum KS statistic KSₘₐₓ observed during this period, and setting h as follows:

$$h = {KS}_{max} \times safety\_factor ( default : 1.5 )$$

Alternatively, h may be set analytically using the asymptotic distribution of the two-sample Kolmogorov-Smirnov test statistic to achieve a target false-positive rate of 1% per round, further adjusted by a Bonferroni correction:

$${α}_{round} = \frac{α}{{R}_{max}}$$

where, α_{round} is the per-round significance level; a is the target false-positive rate (for example, 0.01 for one percent); and Rₘₐₓ is the expected total number of rounds in the system's operational lifetime. In a preferred embodiment, a secondary Cumulative Sum control chart monitor is maintained in parallel with the Kolmogorov-Smirnov test, applying the CUSUM algorithm to the time series of KSᵣ values to detect patterns of gradual monotonic drift that produce individually sub-threshold KS statistics but whose cumulative sum exceeds a CUSUM threshold, providing earlier warning of attacks that ramp up gradually over extended periods. An alert is issued when either the KS test or the CUSUM monitor signals a detection event.

Upon the threshold comparator detecting that KSᵣ exceeds h, the KS Alert 450 is raised and transmitted to the rollback controller 460. The rollback controller 460 immediately executes the following sequence of actions, which in the preferred embodiment are designed to complete with a total latency of less than two seconds from alert receipt to active model reversion. In the GTDM Reversion action 470, the rollback controller 460 first suspends acceptance of any further gradient submissions for the current round; queries the non-repudiation ledger 140 to identify the most recently committed model version node bearing a Verified-Clean marker; loads the model parameter tensor corresponding to the identified Verified-Clean version from a pre-loaded and pre-verified checkpoint maintained in high-speed storage attached to the PRAF Aggregator 110; instructs the model serving infrastructure to replace the active global threat detection model 120 with the loaded parameters; broadcasts a reversion notification to all registered AI Security Agent processes 102a through 102n comprising the version identifier, the SHA-3-256 hash of the restored parameters, and the digital signature of the rollback controller over the notification, enabling each agent to cryptographically verify that the notified reversion is authentic and to reload the correct model version for local inference; and commits a rollback event record to the non-repudiation ledger 140 containing the alert details, the round index, the version identifier of the restored model, and the rollback controller's digital signature.

Concurrent with the GTDM Reversion action 470, the rollback controller 460 initiates the ZKP Verification Round 480 by broadcasting to all registered agents a zero-knowledge proof request comprising the data quality predicate set P_{quality} and the inspection window specification. The data quality predicate set P_{quality} specifies, at minimum, a minimum dataset size nₘᵢₙ, a maximum class imbalance ratio rhoₘₐₓ, and a minimum feature distribution entropy Hₘᵢₙ. Each agent is required to submit, within the timeout T_{zkp}, a zero-knowledge proof demonstrating that its gradient submissions during the inspection window of R_{inpect} most recently preceding rounds were computed from a dataset that satisfies all predicates in P_{quality}, without revealing the content of the dataset. In the preferred embodiment, the zero-knowledge proofs are constructed using a zk-SNARK proof system such as Groth16 applied to an arithmetic circuit encoding the data quality predicates and the gradient computation process, allowing verification of the proof in constant time using the public verification key corresponding to the shared circuit parameters established during system initialization. The Agent Classification node 490 processes the submitted proofs: agents submitting valid proofs within T_{zkp} are classified as Cleared Agents and their participation in subsequent rounds resumes normally; agents failing to submit a valid proof within T_{zkp}, or submitting a proof that fails cryptographic verification, are classified as Suspected Byzantine Agents, their Credibility Weight is set to wₘᵢₙ for R_{quality} subsequent rounds, and a Suspected Byzantine classification record is committed to the non-repudiation ledger 140 with full evidentiary details.

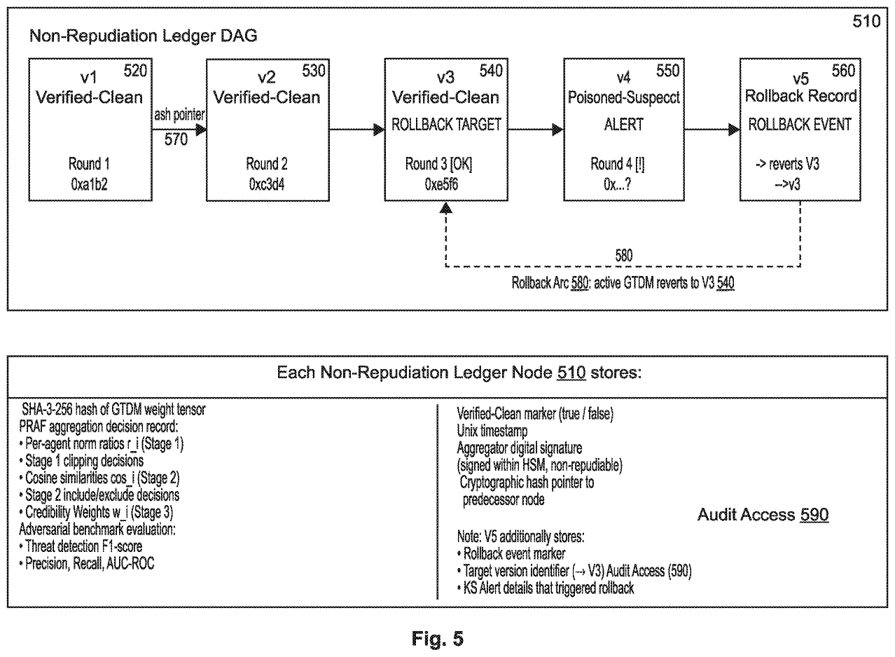

Referring now to FIG. 5, the non-repudiation ledger 140 will be described in complete detail. The non-repudiation ledger 140 is implemented as a directed acyclic graph in which each node represents one version of the global threat detection model 120. In FIG. 5, the ledger is bounded by the outer navy rounded-rectangle representing the non-repudiation ledger DAG 510. A plurality of exemplary version nodes are illustrated: V1 at element 520, V2 at element 530, V3 at element 540, V4 at element 550, and V5 at element 560. Hash Pointers 570 connect each version node to the chronologically next, with each pointer storing the SHA-3-256 hash of the complete content of the predecessor node, forming a cryptographic chain in which any retroactive modification of any historical node's content would cause the hash pointer in the immediately succeeding node to be inconsistent with the modified content, creating a detectable and irrefutable chain integrity violation.

Each node in the non-repudiation ledger 140 stores, in a structured and cryptographically signed data record, the following information: first, the SHA-3-256 hash of the complete model weight tensor corresponding to the model version represented by that node, allowing any party to independently verify the integrity of any cached model parameter set by recomputing its hash and comparing it to the committed value; second, the complete PRAF aggregation decision record for the federated round that produced this version, comprising for each participating agent process the norm ratio rᵢ from Stage 1, the Stage 1 clipping decision, the cosine similarity value from Stage 2, the Stage 2 inclusion or exclusion decision, and the Credibility Weight wᵢ applied in Stage 3; third, the adversarial benchmark evaluation record comprising the threat detection F1-score, precision, recall, and area under the receiver operating characteristic curve achieved by this model version on the held-out adversarial benchmark dataset at the time of commitment; fourth, a Verified-Clean marker that is set to true if and only if all evaluation metrics in the adversarial benchmark evaluation record meet or exceed their respective configurable minimum thresholds; fifth, a Unix timestamp recording the precise moment of node commitment; sixth, the cryptographic hash pointer to the immediately preceding version node in the ledger; and seventh, the digital signature of the PRAF aggregator 110 over the complete content of the node, computed using the aggregator's private key held in the Hardware security module, constituting the aggregator's non-repudiable attestation that the node faithfully records the PRAF computation performed for that round. In FIG. 5, versions V1 (520), V2 (530), and V3 (540) bear verified-clean markers. Version V4 (550) bears a poisoning-suspect marker indicating that the poisoning detection monitor 114 raised a KS Alert at or after this version's commitment. Version V5 (560) is the rollback record node created by the rollback controller 460. The Rollback Arc 580 shown as a dashed curve from V5 (560) to V3 (540) represents the reversion of the active global threat detection model 120 to the parameters of V3 (540), the most recent Verified-Clean version. Access to the non-repudiation ledger 140 by authorised auditors is indicated by the Audit Access marker 590, with access governed by a role-based access control system maintaining separate permissions for read access, write access, and administrative access.

A first embodiment of the system 100 will now be described in complete detail, corresponding to a cloud-deployed centralized aggregator architecture. In the first embodiment, the PRAF Aggregator 110 is hosted on a dedicated cloud computing cluster provisioned by the deploying organization, with the Aggregator's cryptographic operations performed within a Hardware security module certified to FIPS 140-3 Level 3 or equivalent, ensuring that private signing keys are stored in tamper-resistant hardware and are not accessible to any software process running on the Aggregator host platform. AI Security Agent processes 102a through 102n communicate with the PRAF Aggregator 110 exclusively over mutually authenticated TLS 1.3 connections, with each agent's identity authenticated using an X.509 certificate issued by the system's dedicated certificate authority upon agent registration, and with the certificate's associated private key stored in the agent's local trusted execution environment or hardware security module. Agent registration is a controlled onboarding process in which the candidate agent process generates a key pair within its local secure enclave, submits the public key to the PRAF Aggregator 110 along with the agent's organizational identifier and attested hardware configuration, receives a signed X.509 certificate from the system's certificate authority, downloads the current version of the global threat detection model 120 with verification of the parameter hash committed in the non-repudiation ledger 140, receives its initial Beta distribution parameters αᵢ equals βᵢ equals one, and receives the full set of system configuration parameters including the clipping multiplier tau, the cosine similarity threshold theta, the per-round privacy budget ground, the lifetime privacy budget εₜₒₜₐₗ, the reference window size K, the detection threshold h, the ZKP timeout T_{zkp}, the penalty period R_{penalty}, and the Credibility Weight floor wₘᵢₙ.

In the first embodiment, the adversarial benchmark dataset used to evaluate each committed model version is maintained by the PRAF Aggregator 110 and is refreshed quarterly by the system operator with current threat samples obtained from threat intelligence feeds, red team exercise records, and confirmed security incident case studies, ensuring that the benchmark reflects the current threat landscape. The benchmark evaluation is performed in a sandboxed compute environment isolated from the production inference serving infrastructure to prevent any influence of the benchmark process on live threat detection operations. The model serving infrastructure in the first embodiment implements a blue-green deployment pattern in which the model rolled back to V3 (540) is deployed as the new active blue model while the model running in the current production environment transitions to the inactive green slot, enabling zero-downtime model reversion and providing a rapid rollback path in the event that the restored model proves unsatisfactory.

In the first embodiment, the local training objective executed at each AI security agent process 102 comprises the cross-entropy classification loss L_{CE} computed over the agent's local training dataset Dᵢ and a configurable adversarial robustness regularisation term λ times R_{adv}, i.e.:

$${ℒ}_{local} = {L}_{CE} + λ \cdot {R}_{adv}$$

where, [symbol] _{local} is the combined local training objective; L_{CE} is the cross-entropy classification loss computed over the agent's local training dataset Dᵢ; λ is the configurable regularisation coefficient with a preferred default value of 0.1; and R_{adv} is the adversarial robustness regularisation term computed using the Projected Gradient Descent adversarial training method.

Rady is computed using the Projected Gradient Descent adversarial training method as follows: for each mini-batch of training samples, up to K_{adv} adversarial perturbation steps are applied to each sample input feature vector, each step moving in the direction of the gradient of L_{CE} with respect to the input features and projecting back onto the L-infinity ball of radius ε_{adv} centred at the clean sample, where K_{adv} has a preferred default of 10 steps and ε_{adv} is set to 3% of the average feature range. The combined loss L_{CE}+λ times R_{adv} is minimized with respect to the model parameters, causing the local model to learn both accurate classification on clean telemetry and robustness to small input-space perturbations representing evasive variants of known threat patterns. The regularization coefficient λ has a preferred default value of 0.1. Local training is performed for E local epochs (preferred default five) using mini-batch stochastic gradient descent with batch size 32.

A second embodiment of the present invention will now be described, corresponding to a decentralized peer-to-peer aggregation architecture in which the PRAF Aggregator function is distributed among the AI security agent processes themselves, eliminating the requirement for dedicated central server infrastructure and providing resilience against the failure or compromise of any single aggregation node. In the second embodiment, at the commencement of each federated round r, a Round Aggregator is designated from among the N registered AI security agent processes using a deterministic, verifiable, and Byzantine-fault-tolerant leader election protocol. In the preferred implementation, the leader election uses a verifiable random function applied to a shared seed derived from the hash of the prior round's non-repudiation ledger node, producing a pseudorandom but verifiable permutation of agent identifiers that determines the aggregator rotation schedule. The Round Aggregator designation is publicly verifiable by all agents from the shared seed, preventing any agent from claiming the aggregator role fraudulently. The Round Aggregator role rotates across all registered agents across successive federated rounds in the order determined by the current permutation, ensuring that no single agent accumulates a disproportionate number of aggregation rounds that could be exploited to bias the aggregation outcome.

In the second embodiment, gradient transmission proceeds as in the first embodiment, with each agent computing and signing its privatized gradient vector and transmitting it to the designated Round Aggregator. The Round Aggregator applies the three-stage PRAF as described above with reference to FIG. 2, computes g_{agg}, and updates its local copy of the global threat detection model 120. The Round Aggregator also computes and commits the updated model version node to the replicated non-repudiation ledger. In the second embodiment, the non-repudiation ledger 140 is replicated across all N AI Security Agent processes using a Byzantine fault-tolerant distributed consensus protocol based on Practical Byzantine Fault Tolerance extended to handle a variable number of participants and to accommodate the rotating aggregator architecture. Each version node committed to the non-repudiation ledger 140 is considered finalized and irrevocable only after it has received threshold signatures from a supermajority of Q agents, where Q is:

$$Q = ⌊ \frac{2 N}{3} ⌋ + 1$$

where, Q is the supermajority threshold representing the minimum number of agent digital signatures required before a version node is considered finalized; and N is the total number of AI Security Agent processes registered with the system. Any agent that detects an inconsistency between the PRAF decision record published by the Round Aggregator and its own independently received set of gradient vectors may challenge the committed node by publishing the inconsistency evidence to the other agents, triggering a Byzantine fault recovery procedure.

In the second embodiment, the Poisoning Detection Monitor 114 is executed independently by each agent in parallel, with each agent computing its own estimate of KSᵣ from the set of gradient vectors it received directly. Agents share their computed KSᵣ values with one another, and a consensus KSᵣ value is computed as the median of all reported values, providing Byzantine fault tolerance for the detection mechanism itself. If the consensus KSᵣ exceeds the threshold h, any agent may initiate the rollback controller 460 protocol by broadcasting a signed rollback request to all agents. The rollback request is executed if it receives endorsements from a supermajority of Q agents, preventing a minority of Byzantine agents from triggering spurious rollback events. In a variant of the second embodiment, the non-repudiation ledger 140 is implemented on a permissioned blockchain platform such as Hyperledger Fabric or Hyperledger Besu, providing standardized smart-contract-based validation of PRAF decision records, cryptographic finality guarantees for committed version nodes, and integration with existing enterprise blockchain governance frameworks.

The second embodiment provides distinct operational advantages over the first embodiment in deployment scenarios where a centralized aggregation server is operationally undesirable or technically infeasible, including: highly distributed deployments spanning multiple cloud providers and geographic regions where no single cloud provider is trusted by all participating organizations; regulatory environments that prohibit the concentration of gradient data at a single third-party computing facility; and high-availability requirements where the failure of a single central aggregator would cause the entire federated training process to halt. The second embodiment trades increased communication overhead—as gradients must be transmitted to the designated Round Aggregator rather than to a stable central server, and non-repudiation ledger replication requires additional inter-agent communication—for the elimination of the central aggregator as a single point of failure or trust.

A third embodiment of the present invention will now be described, corresponding to a hierarchical two-level federated architecture designed for deployment in multi-tenant enterprise environments in which multiple organizational tenants, each comprising its own fleet of AI Security Agent processes monitoring its own network infrastructure, participate in a shared federated training process while maintaining strict confidentiality of their respective security telemetry patterns from other tenants and from the global aggregation operator.

In the third embodiment, the system is organized as a hierarchy with two levels of aggregation. At the lower level, each organizational tenant Tk, for k from one to M where M is the total number of tenants, operates a dedicated Tenant Aggregator. Each Tenant Aggregator collects privatized gradient submissions from the AI Security Agent processes belonging to tenant Tₐₗₑᵣₜ, applies the full three-stage PRAF pipeline as described above with reference to FIG. 2 to produce a tenant-level aggregated gradient g_{aggk}, and maintains a per-tenant Beta Distribution credibility model registry for each of its local agent processes. The per-agent credibility model update cycle described with reference to FIG. 3 is applied independently within each tenant, with the Tenant Aggregator serving the role of the PRAF Aggregator 110 for its local agents. At the upper level, a Global Aggregator collects the tenant-level aggregated gradients {g_{agg1}, g_{agg2}, . . . , g_{aggM}} from all M Tenant Aggregators and applies a second pass of the three-stage PRAF pipeline to these M tenant-level gradients to produce the globally aggregated gradient g_{aggglobal}, which is used to update the shared global threat detection model 120. The Global Aggregator maintains a global-level Beta Distribution credibility model for each tenant aggregator, treating each tenant aggregator as an agent in the global PRAF computation. This two-level credibility modeling structure provides protection at both levels: within each tenant, legitimate agents are amplified and Byzantine agents are attenuated by the tenant-level credibility model; at the global level, tenants whose submitted aggregated gradients consistently correlate with global model improvement are amplified, while tenants whose submissions correlate with global model deterioration are attenuated.

Cross-tenant privacy is preserved in the third embodiment through the application of a two-stage privacy protection protocol. In the first stage, each Tenant Aggregator applies the standard per-agent differential privacy noise injection as described above before aggregating its local agents' gradients, ensuring that the tenant aggregator's output g_{agg_k} does not allow the Global Aggregator to reconstruct any individual local agent's gradient. In the second stage, before transmitting g_{agg_k} to the global aggregator, each tenant aggregator participates in a secure multi-party computation protocol based on Shamir's secret sharing: each tenant aggregator Tk splits its aggregated gradient g_{agg_k} into M shares using a threshold secret sharing scheme with reconstruction threshold:

$${t}_{Shamir} = ⌈ \frac{2 M}{3} ⌉ + 1$$

where, t_{Shamir} is the minimum number of shares required to reconstruct the original gradient; and M is the total number of tenant aggregators. Each tenant aggregator transmits one share to each of the M−1 peer tenant aggregators and retains one share locally. The global aggregator collects one share from each tenant aggregator and can reconstruct from these shares only the sum of all M tenant-level gradients. The global aggregator cannot reconstruct the individual tenant-level gradient g_{agg_k} for any single tenant k, ensuring that no tenant's proprietary security telemetry patterns, threat detection focus areas, or network topology characteristics can be inferred by the Global Aggregator or by any other tenant. In a variant of the third embodiment, the Shamir secret sharing is replaced by a homomorphic encryption scheme in which each Tenant Aggregator encrypts its gradient under the global aggregator's public key using a partially homomorphic scheme supporting addition, allowing the global aggregator to compute the sum of encrypted gradients and decrypt the sum without decrypting any individual encrypted gradient.

The third embodiment provides distinct advantages in the following deployment scenarios: large enterprise organizations with multiple business units or subsidiaries that operate separate IT environments but wish to benefit from a shared threat detection model trained on all units' telemetry without any business unit's sensitive operational data patterns being visible to other units; industry consortia in which competing organizations in the same sector wish to jointly maintain a sector-wide threat detection model that benefits from all members' threat intelligence while preserving competitive confidentiality; and government or regulated-industry environments in which data sharing across organizational or classification boundaries is prohibited by regulatory requirements but collaborative threat model improvement is operationally desirable. The third embodiment reduces bandwidth requirements relative to the first and second embodiments because only M tenant-level aggregated gradients, rather than N individual agent gradients, are transmitted to the Global Aggregator, which is advantageous when N is large and bandwidth between tenant environments and the global aggregation facility is constrained.

A first method embodiment corresponding to the Standard Operating Procedure for a single federated round under normal conditions, will now be described as a complete sequence of steps. Step A-1, the Round Initiation step, is performed by the PRAF Aggregator 110, which broadcasts to all N registered AI Security Agent processes 102a through 102n a round-start notification comprising the federated round index r, the SHA-3-256 hash H(θᵣ) of the current model parameter tensor Or, the current round-specific privacy budget ε_{round} derived from the remaining lifetime budget, and an authenticated timestamp. Step A-2, the Agent Verification and Local Training step, is performed by each agent i: the agent verifies the authenticity of the round-start notification using the PRAF Aggregator's public key; confirms that the hash of its locally cached model parameters matches H(θᵣ); and trains the local model on its local dataset Dᵢ for E epochs as described above, producing the raw local gradient Gt. Step A-3, the Differential Privacy Noise Injection step, is performed by each agent: the agent computes the noise standard deviation σₗ for each layer [symbol] according to the noise standard deviation formula disclosed above; samples independent Gaussian noise with the computed standard deviation for each layer; adds the noise to each layer's gradient to produce the privatized gradient gᵢ; and updates the cumulative privacy expenditure tracker using the moments accountant. Step A-4 is the gradient transmission step: each agent computes the digital signature σ_{sign_i} over the concatenation of gᵢ, r, and the agent's unique identifier using the agent's private key; transmits the tuple (gᵢ, θ_{sign_i}, agent_id_i) to the PRAF Aggregator 110 via the mutually authenticated TLS connection; and records the transmission in its local agent activity log. Agents that fail to transmit within the synchronisation window W_{sync} of 60 seconds are recorded as non-participants for round r. Step A-5, the Signature Verification step: the PRAF Aggregator 110 verifies the digital signature of each received gradient submission; records the verification result in the non-repudiation ledger staging buffer; and discards any submission with an invalid or missing signature. Step A-6 is the PRAF Application step: the PRAF Aggregator 110 applies Stages 1, 2, and 3 of the PRAF as described above with reference to FIG. 2, computing in sequence the Geometric Median g_{med}, the clipped set S1, the cosine-similarity-filtered set S2, and the Credibility-Weighted Average g_{agg}. Step A-7 is the Global Model Update step: the PRAF Aggregator 110 applies g_{agg} to update the model parameters θᵣ using the Adam optimiser with global learning rate eta_{global} of 0.0 zero one, momentum coefficient β₁ of 0.9, and second-moment coefficient β₂ of 0.999, producing θᵣ₊₁. Step A-8 is the non-repudiation ledger Commitment step: the PRAF Aggregator 110 evaluates θᵣ₊₁ on the adversarial benchmark dataset; determines the Verified-Clean status; constructs the complete version node record; computes the SHA-3-256 hash of θᵣ₊₁; adds the cryptographic hash pointer to the preceding node; signs the complete node record using the Hardware security module; and commits the signed node to the non-repudiation ledger 140. Step A-9 is the Credibility Weight Update step: the PRAF Aggregator 110 computes the F1-score change ΔF1ᵢ for each agent i as described above with reference to FIG. 3; updates αᵢ or βᵢ accordingly; recomputes and floors wᵢ; and commits all updated credibility parameters to the non-repudiation ledger 140. Step A-10 is the Poisoning Detection step: the poisoning detection monitor 114 computes KSᵣ and, if KSᵣ does not exceed h, records the result and awaits the next round-start trigger; if KSᵣ exceeds h, the rollback controller 460 is activated as described above with reference to FIG. 4.

A second method embodiment referred to as the high-threat expedited mode, will now be described. This embodiment is automatically activated by the system 100 when the global threat detection model 120 as deployed in the production inference serving environment exhibits a measured threat detection F1-score on a continuously monitored holdout evaluation set that falls below a configurable alert threshold Tₐₗₑᵣₜ, having a preferred default value of 90% of the F1-score achieved by the most recent Verified-Clean model version on the same evaluation set. The drop in production F1-score below Tₐₗₑᵣₜ, indicates potential model compromise and triggers the High-Threat Expedited Mode to accelerate detection and remediation. The second embodiment modifies the following operating parameters relative to first embodiment. First, the gradient submission synchronization window W_{sync} is reduced from 60 seconds to 15 seconds. Second, the detection threshold h 440 applied by the threshold comparator in FIG. 4 is reduced from 0.30 to 0.15, increasing the sensitivity of the poisoning detection monitor 114. Third, the reference window size K used to compute the reference distribution F_{ref} is reduced from 10 rounds to 3 rounds. Fourth, the number of local training epochs E is reduced from 5 to 1 per round. Fifth, the ZKP timeout T_{zkp}, for the zero-knowledge proof verification round is reduced from 30 seconds to 10 seconds. Sixth, an enhanced gradient scrutiny protocol is activated: any agent whose current Credibility Weight wᵢ falls below a configurable enhanced scrutiny threshold w_{scrutiny}, having a preferred default of 0.35, is required to submit within 5 seconds of the round-start notification a signed gradient provenance attestation identifying the specific training data sample indices from which the submitted gradient was computed. Failure to submit the signed attestation within the five-second window results in immediate exclusion of that agent's gradient from the PRAF computation for the current round and the agent's classification as a Suspected Byzantine Agent for the current round only, with its Credibility Weight reduced by a penalty increment of 0.1 for the subsequent round. The second embodiment is automatically deactivated and all parameters reverted to their first embodiment values when the global threat detection model 120 achieves a production F1-score meeting or exceeding Tₐₗₑᵣₜ for 5 consecutive rounds, indicating that model integrity has been restored.

A third method embodiment referred to as the privacy-critical differential privacy enhanced mode, will now be described. The third embodiment is designed for deployment contexts subject to regulatory data privacy requirements under which the standard per-round differential privacy parameterization of the first embodiment may provide an insufficient formal privacy guarantee for the specific types of security telemetry involved. Such contexts include AI security agent deployments in healthcare networks governed by the Health Insurance Portability and Accountability Act in the United States, financial networks governed by the Payment Card Industry Data Security Standard, and deployments in jurisdictions governed by the General Data Protection Regulation. In the third embodiment, the per-round privacy budget ε_{round} is reduced from the standard value of 1.0 to 0.1, providing a substantially tighter formal differential privacy guarantee at the expense of substantially increased noise magnitude injected into each agent's gradient. To compensate for the increased noise without unacceptable degradation of model accuracy, the third embodiment applies the following three supplementary mechanisms in combination. The first supplementary mechanism is Secure Aggregation as introduced by Bonawitz et al. in 2017, which allows the noise calibration to be computed with respect to the aggregate gradient sensitivity of the sum rather than the individual gradient sensitivity, reducing the required noise standard deviation by the following factor:

$${σ}_{SA} \approx \frac{{σ}_{indiv}}{\sqrt{N}}$$

where, σ_{SA} is the noise standard deviation required when Secure Aggregation is used; σ_{indiv} is the noise standard deviation required for individual gradient transmission; and N is the total number of participating agents. This reduction substantially improves the signal-to-noise ratio of the aggregated gradient without weakening the formal privacy guarantee. The second supplementary mechanism is top-K gradient sparsification: each agent transmits only the K gradient components with the largest absolute magnitude, where K is determined as follows:

$$K = 0.01 \times d$$

where, K is the number of transmitted gradient components; and d is the total number of model parameters in the global threat detection model 120. Sparsification reduces the effective dimensionality of the transmitted gradient and thereby reduces the noise magnitude required to achieve the target ε-differential privacy guarantee for the specified gradient sensitivity. The third supplementary mechanism is credibility weight gating: because secure aggregation prevents the PRAF aggregator 110 from observing individual agents' gradient vectors, Stages 1 and 2 of the PRAF cannot be applied to individual gradients. To maintain Byzantine fault tolerance, the PRAF Aggregator 110 publishes, before each round, an exclusion list of agents whose credibility weight wᵢ falls below a configurable secure aggregation exclusion threshold w_{SA}, having a preferred default of 0.20. Agents on the exclusion list are not included in the secure aggregation protocol for that round; their gradients are not aggregated. The PRAF is then applied to the reconstructed aggregate sum as a single input, with the poisoning detection monitor 114 continuing to operate on the distribution of the per-agent gradient magnitudes reported by the agents for transparency purposes. The three supplementary mechanisms together allow the third embodiment to provide the following formal guarantee:

$${ε}_{roun {d}_{( C )}} = 0.1 ; Accuracy \geq {Acc}^{( A )} - 5 \% ( N \geq 50 )$$

where, ε_{round}_{_{(C)}} is the per-round differential privacy budget in Method Embodiment C; Acc^{(A)} is the model accuracy achieved under Method Embodiment A with ε_{round} equals 1.0; and N is the agent population size. This guarantee holds at agent population sizes of N≥50.

In addition to the system and method embodiments described above, the present invention may be embodied in one or more non-transitory computer-readable media. The term “non-transitory computer-readable medium,” as used herein, refers to any tangible medium that can store instructions executable by one or more processors, including without limitation magnetic storage media such as hard disk drives and magnetic tape; optical storage media such as compact discs, digital versatile discs, and Blu-ray discs; solid-state storage media such as flash memory, solid-state drives, and electrically erasable programmable read-only memory; and any combination thereof. The term “non-transitory” expressly excludes transitory propagating signals but does not exclude media that temporarily store instructions in volatile memory during execution. A single non-transitory computer-readable medium, or a distributed plurality of such media, may store the instructions described herein.

In another aspect, the present invention provides one or more non-transitory computer-readable media storing instructions that, when executed by one or more processors, cause the one or more processors to implement a method for Byzantine-fault-tolerant federated training of an artificial intelligence security threat detection model. The method implemented by said instructions comprises: receiving a plurality of privatized gradient vectors from a plurality of artificial intelligence security agent processes, each privatized gradient vector having been computed from a local threat detection model trained on security telemetry locally observed by the respective agent process and having been perturbed by adding to each model layer [symbol] independently sampled Gaussian noise with a standard deviation σ [symbol] computed as the product of a global clipping threshold C and the gradient sensitivity Δ [symbol] of that layer divided by a per-round privacy budget εround; verifying a digital signature accompanying each received privatized gradient vector using a public key registered for the transmitting agent process, and discarding any gradient vector whose digital signature verification fails; computing a Geometric Median of the set of verified privatized gradient vectors using an iterative Weiszfeld algorithm that initializes at the coordinate-wise median of the input vectors and updates iteratively by computing the weighted centroid of the input vectors wherein the weight of each input vector is the reciprocal of the Euclidean distance from that input vector to the current Geometric Median estimate, using a smoothing constant of 10⁻⁸ to prevent division by zero, and terminating when the Euclidean norm of the update step falls below a convergence tolerance of 10⁻⁶ or after 100 iterations; applying Geometric Median Clipping comprising rescaling each verified privatized gradient vector whose Euclidean norm exceeds the product of a configurable clipping multiplier τ and the Euclidean norm of the Geometric Median so that the rescaled vector's Euclidean norm equals said product while its direction is preserved, logging the norm ratio of each agent process to a Non-Repudiation Ledger, and producing a first filtered set S1; applying Cosine Similarity Filtering comprising computing for each gradient vector in the first filtered set the cosine similarity with the Geometric Median as the inner product of the two vectors divided by the product of their Euclidean norms, excluding any gradient vector whose cosine similarity is strictly less than a configurable minimum threshold θ, logging each inclusion and exclusion decision to the Non-Repudiation Ledger, and producing a second filtered set S2; computing a Credibility-Weighted Average gradient by multiplying each gradient vector in the second filtered set by the Credibility Weight of its contributing agent process, summing the resulting weighted gradient vectors, and dividing by the sum of all Credibility Weights associated with agent processes whose gradient vectors are included in the second filtered set, wherein each Credibility Weight is the ratio of the agent process's cumulative correct-prediction count to the sum of its cumulative correct-prediction count and cumulative incorrect-prediction count subject to a configurable floor value wmin, and wherein the cumulative correct-prediction count is incremented by one when the agent process's gradient submission for a federated round is associated with a non-negative change in the threat detection F1-score of the updated Global Threat Detection Model on the agent process's local evaluation dataset and the cumulative incorrect-prediction count is incremented by one when associated with a negative change; updating a global threat detection model with the credibility-weighted average gradient using the Adam optimizer with global learning rate n equal to 0.001, first-moment exponential decay coefficient β1 equal to 0.9, and second-moment exponential decay coefficient β2 equal to 0.999; committing the updated Global Threat Detection Model as a new version node to the Non-Repudiation Ledger, the version node comprising a SHA-3-256 cryptographic hash of the updated model weight tensor, a complete aggregation decision record comprising per-agent norm ratios, Geometric Median Clipper decisions, cosine similarity values, Cosine Similarity Filter decisions, and Credibility Weights applied, adversarial benchmark evaluation metrics, a Verified-Clean marker set to true if and only if all benchmark metrics meet their respective configurable minimum thresholds, a Unix timestamp, a cryptographic hash pointer containing the SHA-3-256 hash of the complete content of the immediately preceding version node, and the digital signature of the one or more processors over the complete version node content; computing a Kolmogorov-Smirnov statistic for the current federated round as the supremum over all non-negative real values of the absolute difference between the empirical cumulative distribution function of the Euclidean norms of all received privatized gradient vectors in the current round and a reference empirical cumulative distribution function computed as the point-wise average of the empirical cumulative distribution functions of gradient vector Euclidean norms from each of the K most recently preceding federated rounds, wherein K is a configurable reference window size with a preferred default value of 10; and, upon the Kolmogorov-Smirnov statistic exceeding a configurable Detection Threshold h, reverting the active global threat detection model to the model weight tensor stored in the most recently committed version node in the non-repudiation ledger bearing a verified-clean marker within a target latency of 2 seconds from the time the Kolmogorov-Smirnov statistic is determined to exceed the detection threshold, and concurrently initiating a zero-knowledge proof verification round in which each registered artificial intelligence security agent process is required to submit, within a configurable timeout, a zero-knowledge proof demonstrating that its gradient vector submissions during a specified inspection window of most recently preceding federated rounds were computed from a local training dataset satisfying a minimum dataset size, a maximum class imbalance ratio, and a minimum feature distribution entropy criterion, without revealing the content of the local training dataset, and classifying as a Suspected Byzantine agent process any agent process that fails to submit a valid zero-knowledge proof within the timeout, reducing the credibility weight of each Suspected Byzantine agent process to the floor value wmin for a configurable penalty period of subsequent federated rounds, and committing a classification record for each suspected Byzantine agent process to the non-repudiation ledger.

In certain embodiments, the one or more non-transitory computer-readable media further store instructions that, when executed by the one or more processors, additionally cause the one or more processors to: maintain, for each registered artificial intelligence security agent process i, a pair of non-negative integer count parameters αi and βi defining a Beta probability distribution Beta(αi, βi) over the unit interval, wherein ai is initialized to one and βi is initialized to one at the time of agent registration, and wherein the Credibility Weight wi of agent process i equals the ratio of αi to the sum of αi and βi, subject to the constraint that wi is not less than the configurable floor value wmin; apply temperature scaling to the Credibility Weights before computing the Credibility-Weighted Average by raising each Credibility Weight to the power of the reciprocal of a configurable temperature parameter Tcred and normalizing the resulting values to sum to one, wherein a temperature parameter less than one concentrates the Credibility-Weighted Average toward the gradient vectors of the highest-Credibility-Weight agent processes and a temperature parameter greater than one distributes the Credibility-Weighted Average more uniformly; apply a time-decay adjustment to the Credibility Weight of any agent process that has not transmitted a gradient vector in tinactive consecutive federated rounds by computing an effective Credibility Weight equal to the maximum of the floor value wmin and the product of the quantity (wi minus wmin) and the exponential of the product of the negative of a configurable decay rate λd and tinactive, wherein the stored count parameters αi and βi of the agent process are not modified by said time-decay adjustment; maintain a secondary Cumulative Sum control chart monitor applied to the time series of Kolmogorov-Smirnov statistics across successive federated rounds and raise a poisoning detection alert when the cumulative deviation of the Kolmogorov-Smirnov statistic time series above a reference level exceeds a configurable Cumulative Sum threshold; automatically activate a High-Threat Expedited Mode upon detecting that the inference threat detection F1-score of the active Global Threat Detection Model on a continuously monitored holdout evaluation set falls below a configurable alert threshold Tₐₗₑᵣₜ, wherein activating High-Threat Expedited Mode reduces the gradient submission synchronisation window, reduces the Detection Threshold, reduces the reference window size K, reduces the number of local training epochs, reduces the zero-knowledge proof submission timeout, and requires any agent process whose Credibility Weight is below a configurable enhanced scrutiny threshold wscrutiny to submit a digitally signed training data provenance attestation within a shortened deadline; and apply, in a Privacy-Critical Differential Privacy Enhanced Mode, a Secure Aggregation protocol in which each agent process secret-shares its privatised gradient vector such that the one or more processors reconstruct only the sum of all participating agent processes' privatised gradient vectors, together with a top-K gradient sparsification operation in which each agent process transmits only the K gradient components having the largest absolute magnitudes where K equals 1% of the total number of model parameters d, and a Credibility Weight gating step in which agent processes whose Credibility Weight is below a configurable exclusion threshold wSA are excluded from the Secure Aggregation protocol, collectively providing a formal differential privacy guarantee of εround equal to 0.1 per federated round while maintaining model accuracy within 5% of the accuracy achieved under the standard operating mode at agent population sizes of N≥50.

The methods and processes described herein may be embodied in, and fully or partially automated by, code modules executed by one or more computers or processors. The code modules may be stored in any type of non-transitory computer-readable medium or other computer storage device. Some or all of the methods may alternatively be embodied in specialized hardware. The modules and routines described herein may be implemented in hardware or hardware combined with software. Those skilled in the art will appreciate that the invention may be practiced with various computer system configurations, including multiprocessor systems, microprocessor-based or programmable consumer electronics, minicomputers, mainframe computers, and the like.

The various functions and steps of the described embodiments may be implemented in hardware, firmware, software, or any combination thereof. If implemented in software, the functions may be stored on or encoded as one or more instructions or code on a non-transitory computer-readable medium. A non-transitory computer-readable medium includes all types of tangible computer storage media. Non-transitory computer-readable media include, without limitation, magnetic storage media such as hard disks, floppy disks, and magnetic tape; optical storage media such as compact discs, digital versatile discs, and Blu-ray discs; solid-state storage media such as flash memory devices and solid-state drives; and any other tangible media which can be used to store digital information. The terms “code” and “instructions” as used herein are intended to encompass a broad range of protocols, formats, languages, and interfaces including, without limitation, machine code, assembly code, object code, source code, function call protocols, and scripting languages.

The described embodiments are not limited to any particular computing environment or computing device. The components and steps described herein may be distributed across a plurality of computing devices interconnected by any data communications network, including without limitation local area networks, wide area networks, the Internet, and any combination thereof. Computing devices referenced herein include, without limitation, personal computers, server computers, handheld devices, mobile devices, multiprocessor systems, microprocessor-based systems, programmable consumer electronics, network computers, minicomputers, mainframe computers, distributed computing environments that include any of the above systems or devices, and virtual computing environments. Communications between components of the described systems may be accomplished by any suitable data communications mechanism, including without limitation wired connections, wireless connections, and optical connections.

While the present invention has been described with reference to specific embodiments, it will be understood by those skilled in the art that various changes in form and detail may be made therein without departing from the spirit and scope of the invention as defined by the appended claims. The embodiments described herein are illustrative and not restrictive, and the invention is not limited to the exact details shown and described. Numerous modifications and variations are possible in light of the above teachings, and the invention may be practised otherwise than as specifically described within the scope of the appended claims.

1. A computer-implemented method for training a distributed artificial intelligence security threat detection model in a manner that is resilient to adversarially compromised participating agent processes, the method comprising:
receiving, at a computing system acting as an aggregator, a plurality of gradient vectors from a plurality of distributed artificial intelligence security agent processes, each gradient vector having been computed by the respective agent process from a local model trained on locally observed security telemetry and having been perturbed by the addition of calibrated statistical noise before transmission;
verifying an authentication credential accompanying each received gradient vector and discarding any gradient vector that fails verification;
computing a robust central estimate of the verified gradient vectors using an iterative algorithm that is resistant to the influence of outlying values;
applying a magnitude-based filtering operation that limits the contribution of any individual gradient vector based on its deviation in magnitude from the robust central estimate, thereby producing a first filtered set of gradient vectors;
applying a directional filtering operation that excludes any gradient vector whose directional agreement with the robust central estimate falls below a configurable threshold, thereby producing a second filtered set of gradient vectors;
computing a weighted average of the gradient vectors in the second filtered set, wherein each gradient vector is weighted by a contribution score associated with the agent process that submitted it, and wherein each contribution score is derived from a historical record of whether that agent process's prior gradient submissions have been associated with improvements or deteriorations in the performance of the threat detection model on verified ground-truth security incident data;
updating the artificial intelligence security threat detection model with the weighted average gradient;
recording the updated threat detection model in a tamper-evident version history that cryptographically links each model version to its predecessor, such that any retroactive alteration of a recorded version is detectable;
computing, after each training iteration, a statistical measure of distributional divergence between the gradient magnitude distribution observed in the current training iteration and a reference distribution derived from a plurality of most recently preceding training iterations; and
upon the statistical measure of distributional divergence exceeding a configurable detection threshold:
reverting the active threat detection model to the most recently recorded model version that has been verified as free of adversarial compromise; and
initiating a data provenance verification procedure in which each participating agent process is required to demonstrate, without revealing the content of its training data, that its gradient submissions were derived from training data satisfying minimum quality criteria, and classifying any agent process that fails to provide satisfactory demonstration as a suspected adversarial agent and reducing its contribution score for a subsequent period.

2. The method of claim 1, wherein computing the robust central estimate comprises computing the geometric median of the verified gradient vectors using an iterative weighted-centroid algorithm that initialises at the coordinate-wise median of the input vectors, updates at each iteration by computing the weighted centroid of the input vectors wherein the weight of each input vector is the reciprocal of its distance from the current estimate, and terminates when the magnitude of the update step falls below a convergence tolerance or a maximum number of iterations is reached, wherein a small positive smoothing constant is added to each distance in the denominator to prevent numerical instability.

3. The method of claim 1, wherein the calibrated statistical noise added to each gradient vector before transmission is drawn independently for each layer of the model from a Gaussian distribution whose standard deviation is proportional to the sensitivity of that layer's gradient to the removal of any single training example, divided by a per-iteration privacy expenditure budget, and wherein the cumulative privacy expenditure across all training iterations is tracked and the per-iteration budget is automatically adjusted to ensure that the total expenditure over the operational lifetime of the system does not exceed a configurable lifetime limit.

4. The method of claim 1, wherein each contribution score is maintained as the mean of a Beta probability distribution defined by a pair of count parameters for the respective agent process, wherein one count parameter is incremented by one each time the agent process's gradient submission for a training iteration is associated with a non-negative change in the threat detection performance of the updated model on verified ground-truth security incident data, and the other count parameter is incremented by one each time associated with a negative change, both count parameters are initialised to one at agent registration yielding an initial contribution score of one-half, and a configurable minimum floor value is enforced on each contribution score to prevent any agent process from being permanently excluded from contributing to model updates.

5. The method of claim 1, further comprising applying a time-decay adjustment to the contribution score of any agent process that has not participated in one or more consecutive training iterations, wherein the effective contribution score applied during the weighted averaging stage decays exponentially toward the configurable minimum floor value as the number of consecutive absent training iterations increases, and wherein the stored historical performance counts underlying the contribution score are not modified by the time-decay adjustment and resume governing contribution score updates upon the agent process's return to active participation.

6. The method of claim 1, wherein the tamper-evident version history is implemented as a directed acyclic graph of version records, each version record storing a cryptographic hash of the corresponding threat detection model parameters, a complete record of the filtering and weighting decisions applied to each participating agent process's gradient in the training iteration that produced that model version, adversarial benchmark evaluation results, a verified-clean designation when all evaluation results meet configurable minimum thresholds, a timestamp, a cryptographic hash of the complete content of the immediately preceding version record, and a digital signature of the aggregating computing system over the complete version record, such that any modification of any historical version record causes a detectable inconsistency in the cryptographic hash chain.

7. The method of claim 1, wherein the configurable detection threshold for the statistical measure of distributional divergence is determined by operating the system for a calibration period with a population of known non-adversarial agent processes, recording the maximum value of the statistical measure of distributional divergence observed during the calibration period, and setting the detection threshold to the product of the recorded maximum value and a configurable safety factor, wherein the detection threshold is further adjusted by dividing the per-iteration significance level by the expected total number of training iterations in the operational lifetime of the system to account for the statistical effects of repeated testing.

8. The method of claim 1, wherein the data provenance verification procedure requires each participating agent process to submit a cryptographic zero-knowledge proof demonstrating that the training data from which its gradient submissions during a specified inspection window were derived satisfies a minimum dataset size, does not exceed a maximum class imbalance ratio, and meets a minimum statistical diversity criterion for the distribution of input features, without requiring disclosure of any portion of the training data, and wherein any agent process that fails to submit a satisfactory proof within a configurable timeout is classified as a suspected adversarial agent process, has its contribution score reduced to the minimum floor value for a configurable number of subsequent training iterations, and has a record of its classification and the basis therefor committed to the tamper-evident version history.

9. The method of claim 1, wherein the weighted averaging of gradient vectors in the second filtered set further comprises applying a concentration adjustment to the contribution scores before computing the weighted average, wherein the concentration adjustment raises each contribution score to a power determined by a configurable concentration parameter and normalises the resulting values, such that a concentration parameter less than one concentrates the weighted average toward the gradient vectors of agent processes with the highest contribution scores and a concentration parameter greater than one distributes the weighted average more uniformly across all agent processes whose gradient vectors are included in the second filtered set.

10. The method of claim 1, further comprising automatically activating an expedited operating mode upon detecting that the inference threat detection performance of the active threat detection model on a continuously monitored evaluation dataset falls below a configurable alert threshold, wherein the expedited operating mode reduces the time window within which agent processes must submit gradient vectors, reduces the detection threshold for the statistical measure of distributional divergence, reduces the number of most recently preceding training iterations used to compute the reference distribution, reduces the number of local training iterations performed by each agent process per federated round, requires any agent process whose contribution score falls below a configurable scrutiny threshold to provide a signed attestation of the source of its training data within a shortened deadline, and is automatically deactivated when the inference threat detection performance of the active model meets or exceeds the alert threshold for a configurable number of consecutive training iterations.

11. The method of claim 1, further comprising a privacy-enhanced operating mode in which: a secure aggregation protocol is applied before the magnitude-based filtering stage, wherein each agent process's privatized gradient vector is distributed among participating agent processes using a threshold secret-sharing scheme such that the aggregating computing system reconstructs only the sum of all participating agent processes' privatized gradient vectors and cannot reconstruct any individual agent process's privatized gradient vector; each agent process transmits only a configurable fraction of its gradient components selected by largest absolute magnitude, reducing the effective dimensionality of the transmitted gradient; and agent processes whose contribution scores fall below a configurable exclusion threshold are excluded from the secure aggregation protocol before it commences, such that the combination of the three foregoing mechanisms provides a formal differential privacy guarantee substantially stronger than the standard operating mode while maintaining threat detection model accuracy within a configurable tolerance.

12. A system for training a distributed artificial intelligence security threat detection model in a manner that is resilient to adversarially compromised participating agent processes, the system comprising:
a plurality of artificial intelligence security agent processes, each executing on one or more computing nodes and configured to train a local model on locally observed security telemetry, apply calibrated statistical noise to the resulting gradient vector before transmission, authenticate the resulting privatised gradient vector, and transmit it to an aggregating computing system;
the aggregating computing system comprising one or more processors configured to:
verify authentication credentials accompanying received gradient vectors and discard those that fail verification;
apply a magnitude-based filtering stage that computes a robust central estimate of the verified gradient vectors and limits the contribution of any gradient vector whose magnitude deviates from the robust central estimate by more than a configurable amount;
apply a directional filtering stage that excludes any gradient vector whose directional alignment with the robust central estimate falls below a configurable threshold;
apply a contribution-score-weighted averaging stage that weights each surviving gradient vector by a contribution score derived from the historical performance impact of the contributing agent process's prior submissions on the threat detection model;
compute a statistical measure of distributional divergence between gradient magnitude distributions across successive training iterations and raise a detection alert when the measure exceeds a configurable threshold; and
upon a detection alert, revert the active threat detection model to a verified prior version and initiate a data provenance verification procedure for all participating agent processes;
a threat detection model updated each training iteration with the contribution-score-weighted average gradient; and
a tamper-evident version history that cryptographically records each committed version of the threat detection model and supports reversion to any prior version that has been verified as free of adversarial compromise.

13. The system of claim 2, wherein the aggregating computing system function is performed by a rotating temporary aggregator designated each training iteration from among the plurality of artificial intelligence security agent processes by a deterministic verifiable process applied to a value derived from the tamper-evident version history of the preceding training iteration, and wherein each version record in the tamper-evident version history is not finalised until it has received authenticating approvals from a supermajority of the participating agent processes determined by a configurable quorum threshold, providing resilience against the failure or compromise of any single aggregating node.

14. The system of claim 2, further comprising a hierarchical two-level aggregation architecture in which a plurality of tenant-level aggregating computing systems each applies the magnitude-based filtering stage, the directional filtering stage, and the contribution-score-weighted averaging stage to gradient vectors received from a respective subset of the plurality of artificial intelligence security agent processes to produce a tenant-level aggregated gradient, and a global aggregating computing system collects tenant-level aggregated gradients from all tenant-level aggregating computing systems through a secure multi-party computation protocol in which each tenant-level aggregating computing system distributes shares of its tenant-level aggregated gradient such that the global aggregating computing system reconstructs only the aggregate of all tenant-level aggregated gradients and cannot reconstruct the individual gradient contribution of any single tenant, with contribution scores maintained independently at both the agent level within each tenant and the tenant level at the global aggregating computing system.

15. One or more non-transitory computer-readable media storing instructions that, when executed by one or more processors, cause the one or more processors to perform a method for training a distributed artificial intelligence security threat detection model in a manner that is resilient to adversarially compromised participating agent processes, the method comprising:
receiving a plurality of gradient vectors from a plurality of distributed artificial intelligence security agent processes, each gradient vector having been computed from a local model trained on locally observed security telemetry and perturbed by the addition of calibrated statistical noise, and verifying an authentication credential accompanying each received gradient vector;
computing a robust central estimate of the verified gradient vectors and applying a magnitude-based filtering operation that limits the contribution of any individual gradient vector based on its deviation from the robust central estimate in magnitude, producing a first filtered set;
applying a directional filtering operation that excludes any gradient vector whose directional alignment with the robust central estimate falls below a configurable threshold, producing a second filtered set;
computing a contribution-score-weighted average of the gradient vectors in the second filtered set, wherein each gradient vector is weighted by a contribution score derived from the historical record of whether the contributing agent process's prior gradient submissions have been associated with improvements or deteriorations in the threat detection performance of the model on verified ground-truth security incident data;
updating the threat detection model with the contribution-score-weighted average gradient and recording the updated model in a tamper-evident version history that cryptographically links each model version to its predecessor;
computing a statistical measure of distributional divergence between the gradient magnitude distribution of the current training iteration and a reference distribution derived from a plurality of most recently preceding training iterations; and
upon the statistical measure exceeding a configurable threshold, reverting the active threat detection model to the most recently recorded model version designated as free of adversarial compromise, and initiating a data provenance verification procedure requiring each participating agent process to demonstrate without revealing training data content that its gradient submissions were derived from training data meeting configurable minimum quality criteria, classifying any non-compliant agent process as suspected adversarial and temporarily reducing its contribution score.

16. The one or more non-transitory computer-readable media of claim 15, wherein the instructions further cause the one or more processors to maintain, for each agent process, a pair of count parameters updated after each training iteration based on whether the agent process's gradient submission was associated with improved or degraded threat detection performance, and to derive each agent process's contribution score as the ratio of its positive-outcome count to the sum of its positive-outcome and negative-outcome counts subject to a configurable minimum floor; to apply exponential time-decay to the effective contribution score of agent processes absent from one or more training iterations without modifying the underlying count parameters; to maintain a cumulative-sum statistical process control monitor in parallel with the distributional divergence test for earlier detection of gradually escalating adversarial activity; to automatically activate an expedited operating mode upon detecting degraded model inference performance; and to support a privacy-enhanced operating mode combining secure aggregation, sparse gradient transmission, and contribution-score-based exclusion to provide a substantially stronger formal privacy guarantee without unacceptable degradation of threat detection model accuracy.
